(19) United States
(12) Patent Application Publication
(10) Pub. No.: US 2011/0222031 A1
(43) Pub. Date: Sep. 15, 2011

(54) LIQUID IMMERSION MEMBER, EXPOSURE APPARATUS, LIQUID RECOVERING METHOD, DEVICE FABRICATING METHOD, PROGRAM, AND STORAGE MEDIUM

(75) Inventor: Shinji SATO, Fukaya-shi (JP)

(73) Assignee: NIKON CORPORATION, Tokyo (JP)

(21) Appl. No.: 13/044,874

(22) Filed: Mar. 10, 2011

Related U.S. Application Data
(60) Provisional application No. 61/313,417, filed on Mar. 12, 2010.

(51) Int. Cl. G03B 27/52

(52) U.S. Cl. 355/30

(57) ABSTRACT

A liquid immersion member can form an immersion space such that an optical path of exposure light is filled with a liquid. The liquid immersion member comprises: a recovery port, which recovers at least some of the liquid on an object disposed such that it faces an emergent surface wherefrom the exposure light emerges; a recovery passageway, wherein flows the liquid recovered via the recovery port; a first suction port, which faces the recovery passageway and suctions only a gas from the recovery passageway; and a second suction port, which faces the recovery passageway and suctions the liquid from the recovery passageway

### CROSS-REFERENCE TO RELATED APPLICATION

This application is a non-provisional application claiming priority to and the benefit of U.S. provisional application No. 61/313,417, filed on Mar. 12, 2010. The entire contents of which are incorporated herein by reference.

### BACKGROUND

The present invention relates to a liquid immersion member, an exposure apparatus, a liquid recovering method, a device fabricating method, a program, and a storage medium.

As disclosed in, for example, U.S. Patent Application Publication No. 2009/0046261, among exposure apparatuses used in photolithography, an immersion exposure apparatus is known that exposes a substrate with exposure light through a liquid in an immersion space.

### SUMMARY

In the immersion exposure apparatus, exposure failures might occur if, for example, the immersion space cannot be formed in a desired state. These problems could result in the production of defective devices.

An object of the present invention is to provide a liquid immersion member that can satisfactorily form an immersion space. Another object of the present invention is to provide both an exposure apparatus and a liquid recovering method that can prevent exposure failures from occurring. Yet another object of the present invention is to provide a device fabricating method, a program, and a storage medium that can prevent defective devices from being produced.

A first aspect of the present invention provides a liquid immersion member that can form an immersion space and comprises: a recovery port, which recovers at least some of a liquid on an object disposed such that it faces an emergent surface wherefrom the exposure light emerges; a recovery passageway, wherein flows the liquid recovered via the recovery port; a first suction port, which faces the recovery passageway and suctions only a gas from the recovery passageway; and a second suction port, which faces the recovery passageway and suctions the liquid from the recovery passageway.

A second aspect of the present invention provides a liquid immersion member that forms an immersion space and comprises: a recovery port, which recovers at least some of a liquid on an object disposed such that it faces an emergent surface wherefrom the exposure light emerges; a recovery passageway, wherein flows the liquid recovered via the recovery port; a first suction port, which faces the recovery passageway and continues to suction a gas from the recovery passageway; and a second suction port, which faces the recovery passageway and suctions the liquid from the recovery passageway.

A third aspect of the present invention provides a liquid immersion member that can form an immersion space and comprises: a recovery port, which recovers at least some of a liquid on an object disposed such that it faces an emergent surface wherefrom the exposure light emerges; a recovery passageway, wherein flows the liquid recovered via the recovery port; a first member, which has a first suction port that faces the recovery passageway; and a second member, at least part of whose surface is more lyophilic to the liquid than the first member is, that has a second suction port that faces the recovery passageway; wherein, a gas is suctioned from the recovery passageway via the first suction port of the first member; and the liquid is suctioned from the recovery passageway via the second suction port of the second member.

A fourth aspect of the present invention provides a liquid immersion member that can form an immersion space and comprises: a recovery port, which recovers at least some of a liquid on an object disposed such that it faces an emergent surface wherefrom the exposure light emerges; a recovery passageway, wherein flows the liquid recovered via the recovery port; a first suction port, which is disposed such that it faces the recovery passageway, that suctions a gas from the recovery passageway; and a second suction port, at least part of which is disposed on an outer side of the first suction port in the radial directions with respect to the optical path such that the second suction port faces the recovery passageway, that suctions the liquid in the recovery passageway.

A fifth aspect of the present invention provides a liquid immersion member that can form an immersion space and comprises: a recovery port, which recovers at least some of a liquid on an object disposed such that it faces an emergent surface wherefrom the exposure light emerges; a recovery passageway, wherein flows the liquid recovered via the recovery port; a first suction port, which is disposed above the recovery port and such that it faces the recovery passageway, that suctions a gas from the recovery passageway; and a second suction port, at least part of which is disposed below the first suction port and such that the second suction port faces the recovery passageway, that suctions the liquid in the recovery passageway.

A sixth aspect of the present invention provides an exposure apparatus that exposes a substrate with exposure light, which transits a liquid and comprises: a liquid immersion member according to any one aspect of the first through fifth aspects of the invention.

A seventh aspect of the present invention provides a device fabricating method that comprises the steps of: exposing a substrate using an exposure apparatus according to the sixth aspect of the invention; and developing the exposed substrate.

An eighth aspect of the present invention provides a liquid recovering method used by an exposure apparatus, which exposes a substrate with exposure light via a liquid of an immersion space, and comprises the steps of: recovering via a recovery port at least some of the liquid on the substrate; suctioning via a first suction port, which is disposed such that it faces a recovery passageway wherethrough flows the liquid recovered via the recovery port, only a gas from the recovery passageway; and suctioning via a second suction port, which is disposed such that it faces the recovery passageway, the liquid from the recovery passageway.

A ninth aspect of the present invention provides a liquid recovering method used by an exposure apparatus, which exposes a substrate with exposure light via a liquid of an immersion space, and comprises the steps of: recovering via a recovery port at least some of the liquid on the substrate; continuing to suction via a first suction port, which is disposed such that it faces a recovery passageway wherethrough flows the liquid recovered via the recovery port, a gas from the recovery passageway; and suctioning via a second suction port, which is disposed such that it faces the recovery passageway, the liquid from the recovery passageway.

A tenth aspect of the present invention provides a liquid recovering method used by an exposure apparatus, which exposes a substrate with exposure light via a liquid of an immersion space, and comprises the steps of: recovering via a recovery port at least some of the liquid on the substrate; suctioning via a first suction port, which is disposed in a first member such that it faces a recovery passageway wherethrough flows the liquid recovered via the recovery port, a gas from the recovery passageway; and suctioning the liquid from the recovery passageway via a second suction port, which is disposed in a second member, at least part of whose surface is more lyophilic with respect to the liquid than the first member is, such that the second suction port faces the recovery passageway.

An eleventh aspect of the present invention provides a liquid recovering method used by an exposure apparatus, which exposes a substrate with exposure light via a liquid of an immersion space, and comprises the steps of: recovering via a recovery port at least some of the liquid on the substrate; suctioning via a first suction port, at least part of which is disposed such that it faces a recovery passageway wherethrough flows the liquid recovered via the recovery port, a gas from the recovery passageway; and suctioning via a second suction port, at least part of which is disposed on the outer side of the first suction port in the radial directions with respect to the optical path such that the second suction port faces the recovery passageway, the liquid from the recovery passageway.

A twelfth aspect of the present invention provides a liquid recovering method used by an exposure apparatus, which exposes a substrate with exposure light via a liquid of an immersion space, and comprises the steps of: recovering via a recovery port at least some of the liquid on the substrate; suctioning via a first suction port, which is disposed above the recovery port such that it faces a recovery passageway wherethrough flows the liquid recovered via the recovery port, a gas from the recovery passageway; and suctioning via a second suction port, part of which is disposed below the first recovery port such that the second suction port faces the recovery passageway, the liquid from the recovery passageway.

A thirteenth aspect of the present invention provides a device fabricating method and comprises the steps of: filling an optical path of exposure light radiated to a substrate with a liquid using a liquid recovering method according to any one aspect of the eighth through twelfth aspects of the invention; exposing the substrate with the exposure light, which transits the liquid; and developing the exposed substrate.

A fourteenth aspect of the present invention provides a program that causes a computer to control an exposure apparatus, and comprises the steps of: forming an immersion space; exposing a substrate with exposure light via a liquid of the immersion space; recovering via a recovery port at least some of the liquid on the substrate; suctioning via a first suction port, which is disposed such that it faces a recovery passageway wherethrough flows the liquid recovered via the recovery port, only a gas from the recovery passageway; and suctioning via a second suction port, which is disposed such that it faces the recovery passageway, the liquid from the recovery passageway.

A fifteenth aspect of the present invention provides a program that causes a computer to control an exposure apparatus, and comprises the steps of: forming an immersion space; exposing a substrate with exposure light via a liquid of the immersion space; recovering via a recovery port at least some of the liquid on the substrate; continuing to suction via a first suction port, which is disposed such that it faces a recovery passageway wherethrough flows the liquid recovered via the recovery port, a gas from the recovery passageway; and suctioning via a second suction port, which is disposed such that it faces the recovery passageway, the liquid from the recovery passageway.

A sixteenth aspect of the present invention provides a program that causes a computer to control an exposure apparatus, and comprises the steps of forming an immersion space; exposing a substrate with exposure light via a liquid of the immersion space; recovering via a recovery port at least some of the liquid on the substrate; suctioning via a first suction port, which is disposed in a first member such that it faces a recovery passageway wherethrough flows the liquid recovered via the recovery port, a gas from the recovery passageway; and suctioning the liquid from the recovery passageway via a second suction port, which is disposed in a second member, at least part of whose surface is more lyophilic with respect to the liquid than the first member is, such that the second suction port faces the recovery passageway.

A seventeenth aspect of the present invention provides a program that causes a computer to control an exposure apparatus, and comprises the steps of: forming an immersion space; exposing a substrate with exposure light via a liquid of the immersion space; recovering via a recovery port at least some of the liquid on the substrate; suctioning via a first suction port, which is disposed such that at least part thereof faces a recovery passageway wherethrough flows the liquid recovered via the recovery port, only a gas from the recovery passageway; and suctioning via a second suction port, at least part of which is disposed on the outer side of the first suction port in the radial directions with respect to the optical path such that the second suction port faces the recovery passageway, the liquid from the recovery passageway.

An eighteenth aspect of the present invention provides a program that causes a computer to control an exposure apparatus, and comprises the steps of: forming an immersion space; exposing a substrate with exposure light via a liquid of the immersion space; recovering via a recovery port at least some of the liquid on the substrate; suctioning via a first suction port, which is disposed above the recovery port such that it faces a recovery passageway wherethrough flows the liquid recovered via the recovery port, only a gas from the recovery passageway; and suctioning via a second suction port, at least part of which is disposed below the first recovery port such the faces the recovery passageway, the liquid from the recovery passageway.

A nineteenth aspect of the present invention provides a computer readable storage medium, wherein a program according to any one aspect of the fourteenth through eighteenth aspects of the invention is stored in the storage medium.

According to the aspects of the present invention, an immersion space can be formed satisfactorily. In addition, according to the aspects of the present invention, it is possible to prevent exposure failures from occurring and thereby to prevent defective devices from being produced.

### BRIEF DESCRIPTION OF THE DRAWINGS

FIG. 1 is a schematic block diagram that shows one example of an exposure apparatus according to a first embodiment.

FIG. 2 is a side cross sectional view that shows one example of a liquid immersion member according to the first embodiment.

FIG. 3 shows one example of the liquid immersion member according to the first embodiment, viewed from the upper side.

FIG. 4 shows one example of the liquid immersion member according to the first embodiment, viewed from the lower side.

FIG. 5 is a partial enlarged view of FIG. 2.

FIG. 6 is a schematic drawing for explaining one example of a suction operation of a first suction port.

FIG. 7 is a schematic drawing for explaining one example of a suction operation of a second suction port.

FIG. 8 is a side cross sectional view that shows one example of a liquid immersion member according to a second embodiment.

FIG. 9 is a side cross sectional view that shows one example of a liquid immersion member according to a third embodiment.

FIG. 10 shows one example of the liquid immersion member according to the third embodiment, viewed from the upper side.

FIG. 11 is a side cross sectional view that shows one example of a liquid immersion member according to the third embodiment.

FIG. 12 is a schematic drawing that shows one example of the state of recovered liquid.

FIG. 13 is a flow chart for explaining one example of a microdevice fabricating process.

### DESCRIPTION OF EMBODIMENTS

The following text explains the embodiments of the present invention, referencing the drawings; however, the present invention is not limited thereto. The explanation below defines an XYZ orthogonal coordinate system, and the positional relationships among parts are explained referencing this system. Prescribed directions within the horizontal plane are the X axial directions, directions orthogonal to the X axial directions in the horizontal plane are the Y axial directions, and directions orthogonal to the X axial directions and the Y axial directions (i.e., the vertical directions) are the Z axial directions. In addition, the rotational directions (i.e., the tilting directions) around the X, Y, and Z axes are the θX, θY, and θZ directions, respectively.

### First Embodiment

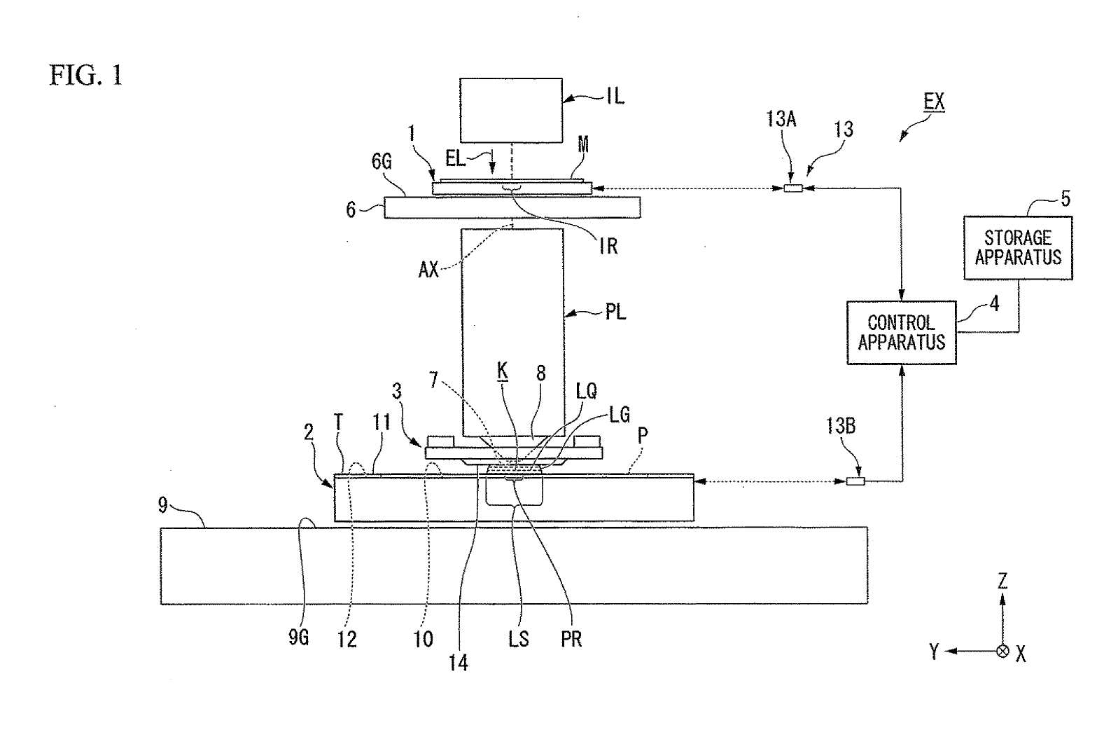

A first embodiment will now be explained. FIG. 1 is a schematic block diagram that shows one example of an exposure apparatus EX according to a first embodiment. The exposure apparatus EX of the present embodiment is an immersion exposure apparatus that exposes a substrate P with exposure light EL that passes through a liquid LQ. In the present embodiment, an immersion space LS is formed so that at least part of an optical path K of the exposure light EL is filled with the liquid LQ. The immersion space LS is a portion (i.e., a space or an area) that is filled with the liquid LQ. The substrate P is exposed with the exposure light EL, which transits the liquid LQ in the immersion space LS. In the present embodiment, water (i.e., pure water) is used as the liquid LQ.

In FIG. 1, the exposure apparatus EX comprises: a movable mask stage 1 that holds a mask M; a movable substrate stage 2 that holds the substrate P; an illumination system IL that illuminates the mask M with the exposure light EL; a projection optical system PL that projects an image of a pattern of the mask M, which is illuminated by the exposure light EL, to the substrate P; a liquid immersion member 3, which forms the immersion space LS by holding the liquid LQ between itself and the substrate P such that the optical path K of the exposure light EL radiated to the substrate P is filled with the liquid LQ; a control apparatus 4, which controls the operation of the entire exposure apparatus EX; and a storage apparatus 5, which is connected to the control apparatus 4 and stores various exposure-related information. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored in the storage apparatus 5.

The mask M is a reticle on which a device pattern to be projected to the substrate P is formed. The mask M is a transmissive mask comprising a transparent plate, such as a glass plate, and the pattern, which is formed on the transparent plate using a shielding material, such as chrome. Furthermore, the mask M may alternatively be a reflective mask.

The substrate P is a substrate for fabricating devices. The substrate P comprises, for example, a base material, such as a semiconductor wafer, and a photosensitive film, which is formed on the base material. The photosensitive film is made of a photosensitive material (e.g., photoresist). In addition to the photosensitive film, the substrate P may include a separate film. For example, the substrate P may include an antireflection film or a protective film (i.e., a topcoat film) that protects the photosensitive film.

The illumination system IL radiates the exposure light EL to a prescribed illumination area IR. The illumination area IR includes a position whereto the exposure light EL that emerges from the illumination system IL can be radiated. The illumination system IL illuminates at least part of the mask M disposed in the illumination region IR with the exposure light EL, which has a uniform luminous flux intensity distribution. Examples of light that can be used as the exposure light EL emitted from the illumination system IL include: deep ultraviolet (DUV) light, such as a bright line (i.e., g-line, h-line, or i-line) light emitted from, for example, a mercury lamp, and KrF excimer laser light (with a wavelength of 248 nm); and vacuum ultraviolet (VUV) light, such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

In the state wherein it holds the mask M, the mask stage 1 is capable of moving on a guide surface 6G of a base member 6 that includes the illumination area IR. The mask stage 1 moves by the operation of a drive system, which comprises a planar motor as disclosed in, for example, U.S. Pat. No. 6,452,292. The planar motor comprises a slider, which is disposed on the mask stage 1, and a stator, which is disposed on the base member 6. In the present embodiment, the mask stage 1 is capable of moving in six directions along the guide surface 6G, namely, the X axial, Y axial, Z axial, θX, θY, and θZ directions, by the operation of the drive system.

The projection optical system PL radiates the exposure light EL to a prescribed projection area PR. The projection area PR includes a position whereto the exposure light EL that emerges from the projection optical system PL can be radiated. The projection optical system PL projects with a prescribed projection magnification an image of the pattern of the mask M to at least part of the substrate P, which is disposed in the projection area PR. The projection optical system PL of the present embodiment is a reduction system that has a projection magnification of, for example, ¼, ⅕, or ⅛. Furthermore, the projection optical system PL may be a unity magnification system or an enlargement system. In the present embodiment, an optical axis AX of the projection optical system PL is parallel to the Z axis. In addition, the projection optical system PL may be a dioptric system that does not include catoptric elements, a catoptric system that does not include dioptric elements, or a catadioptric system that includes both catoptric and dioptric elements. In addition, the projection optical system PL may form either an inverted or an erect image.

The projection optical system PL has an emergent surface 7 wherefrom the exposure light EL emerges and travels toward an image plane of the projection optical system PL. The emergent surface 7 is disposed in a last optical element 8, which is the optical element of the plurality of optical elements of the projection optical system PL that is closest to the image plane of the projection optical system PL. The projection area PR includes a position whereto the exposure light EL that emerges from the emergent surface 7 can be radiated. In the present embodiment, the emergent surface 7 faces the −Z direction and is parallel to the XY plane. Furthermore, the emergent surface 7, which faces the −Z direction, may be a convex or a concave surface. In the present embodiment, the exposure light EL that emerges from the emergent surface 7 proceeds in the −Z direction.

In the state wherein it holds the substrate P, the substrate stage 2 is capable of moving on a guide surface 9G of a base member 9, which includes the projection area PR. The substrate stage 2 moves by the operation of a drive system, which comprises a planar motor as disclosed in, for example, U.S. Pat. No. 6,452,292. The planar motor comprises a slider, which is disposed on the substrate stage 2, and a stator, which is disposed on the base member 9. In the present embodiment, the substrate stage 2 is capable of moving in six directions along the guide surface 9G, namely, the X axial, Y axial, Z axial, θX, θY, and θZ directions, by the operation of the drive system. Furthermore, the drive system (i.e., the linear motor) that moves the substrate stage 2 does not have to be a planar motor.

The substrate stage 2 comprises a substrate holding part 10, which releasably holds the substrate P. The substrate holding part 10 holds the substrate P so that the front surface thereof faces the +Z direction. In the present embodiment, the front surface of the substrate P held by the substrate holding part 10 and an upper surface 11 of the substrate stage 2 disposed around the substrate P are disposed within the same plane (i.e., they are flush with one another). The upper surface 11 is flat. In the present embodiment, the front surface of the substrate P, which is held by the substrate holding part 10, and the upper surface 11 of the substrate stage 2 are substantially parallel to the XY plane. Furthermore, even if the immersion space LS is formed such that it spans the front surface of the substrate P and the upper surface 11 of the substrate stage 2, the upper surface 11 of the substrate stage 2 does not have to be flush with the front surface of the substrate P held by the substrate holding part 10 or flat, as long as the immersion space LS can be maintained. In addition, the upper surface 11 of the substrate stage 2 also includes the front surface of any sensor, measuring member, or the like installed on the substrate stage 2.

In addition, in the present embodiment, the substrate stage 2 comprises a plate member holding part 12, which releasably holds a plate member T, as disclosed in, for example, U.S. Patent Application Publication No. 2007/0177125 and U.S. Patent Application Publication No. 2008/0049209. In the present embodiment, the upper surface 11 of the substrate stage 2 includes the upper surface of the plate member T held by the plate member holding part 12.

Furthermore, the plate member T does not have to be releasable. In such a case, the plate member holding part 12 could be omitted. In addition, the upper surface 11 and the front surface of the substrate P held by the substrate holding part 10 do not have to be disposed within the same plane; furthermore, the front surface of the substrate P or the upper surface 11, or both, may be nonparallel to the XY plane.

In the present embodiment, an interferometer system 13, which comprises laser interferometer units 13A, 13B, measures the positions of the mask stage 1 and the substrate stage 2. The laser interferometer unit 13A is capable of measuring the position of the mask stage 1 using measurement mirrors, which are disposed on the mask stage 1. The laser interferometer unit 13B is capable of measuring the position of the substrate stage 2 using measurement mirrors, which are disposed on the substrate stage 2. When an exposing process or a prescribed measuring process is performed on the substrate P, the control apparatus 4 controls the positions of the mask stage 1 (i.e., the mask M) and the substrate stage 2 (i.e., the substrate P) based on the measurement results of the interferometer system 13.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. In the present embodiment, the scanning directions (i.e., the synchronous movement directions) of both the substrate P and the mask M are the Y axial directions. The control apparatus 4 radiates the exposure light EL to the substrate P through the projection optical system PL and the liquid LQ in the immersion space LS on the substrate P while moving the substrate P in one of the Y axial directions with respect to the projection area PR of the projection optical system PL and moving the mask M, synchronized to the movement of the substrate P, in the other Y axial direction with respect to the illumination area IR of the illumination system IL.

The liquid immersion member 3 forms the immersion space LS such that the optical path K of the exposure light EL radiated to the projection area PR is filled with the liquid LQ. In the present embodiment, some of the liquid LQ in the immersion space LS is held between the emergent surface 7 and an object, which is disposed such that it opposes the emergent surface 7, and at least some of the remaining portion of the immersion space LS is held between the liquid immersion member 3 and the object. In the present embodiment, the object that is capable of being disposed such that it opposes the emergent surface 7, namely, the object that is capable of being disposed in the projection region PR, includes either the substrate stage 2 or the substrate P, which is held by the substrate stage 2, or both. In the exposure of the substrate P, the liquid immersion member 3 forms the immersion space LS by holding the liquid LQ between itself and the substrate P such that the optical path K of the exposure light EL radiated to the substrate P is filled with the liquid LQ.

In the present embodiment, the liquid immersion member 3 is annular. At least part of the liquid immersion member 3 is disposed around the optical path K of the exposure light EL emerging from the last optical element 8 and the emergent surface 7. The immersion space LS is formed such that the optical path K of the exposure light EL between the last optical element 8 and the object disposed in the projection area PR is filled with the liquid LQ.

Furthermore, the liquid immersion member 3 does not have to be annular. For example, the liquid immersion member 3 may be disposed partly around the last optical element 8 and the optical path K.

The liquid immersion member 3 has a lower surface 14 that is capable of opposing the front surface (i.e., the upper surface) of the object disposed in the projection region PR. The lower surface 14 of the liquid immersion member 3 can hold the liquid LQ between itself and the front surface of the object. Holding the liquid LQ between the emergent surface 7 and the lower surface 14 on one side and the front surface (i.e., the upper surface) of the object on the other side forms the immersion space LS such that the optical path of the exposure light EL between the last optical element 8 and the object is filled with the liquid LQ.

In the present embodiment, when the substrate P is being irradiated with the exposure light EL, the immersion space LS is already formed such that part of the area of the front surface of the substrate P that includes the projection region PR is covered with the liquid LQ. At least part of an interface LG (i.e., a meniscus or edge) of the liquid LQ is formed between the lower surface 14 of the liquid immersion member 3 and the front surface of the substrate P. Namely, the exposure apparatus EX of the present embodiment adopts a local liquid immersion system.

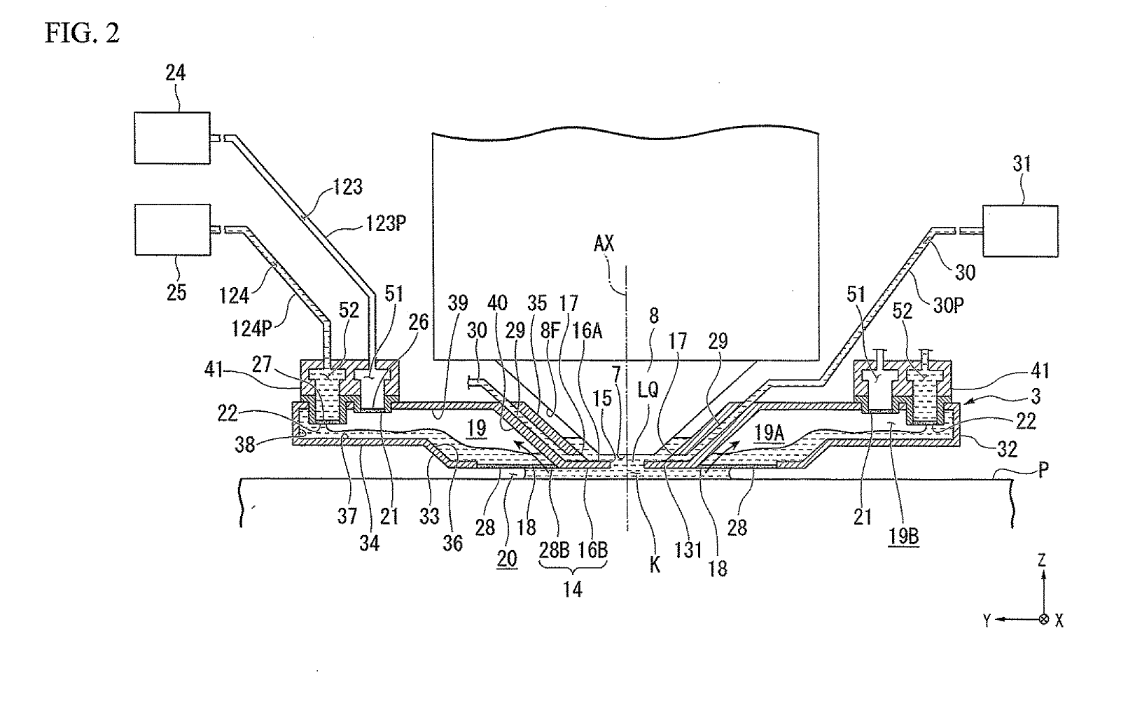

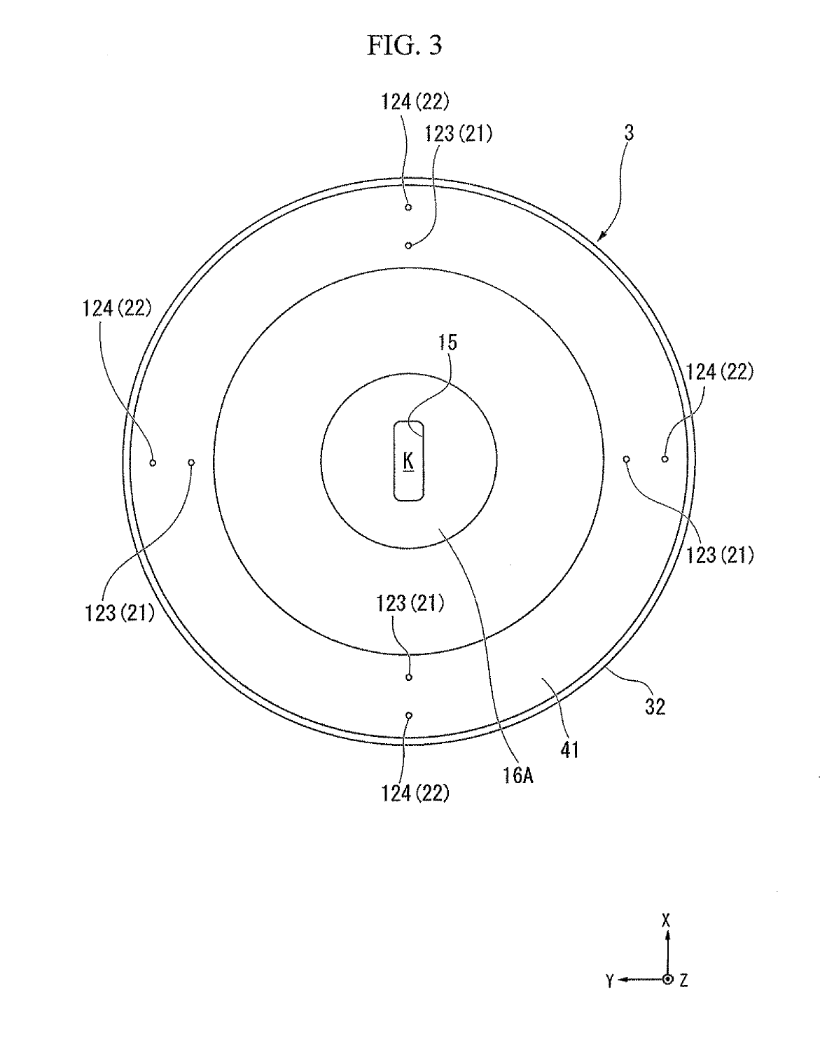

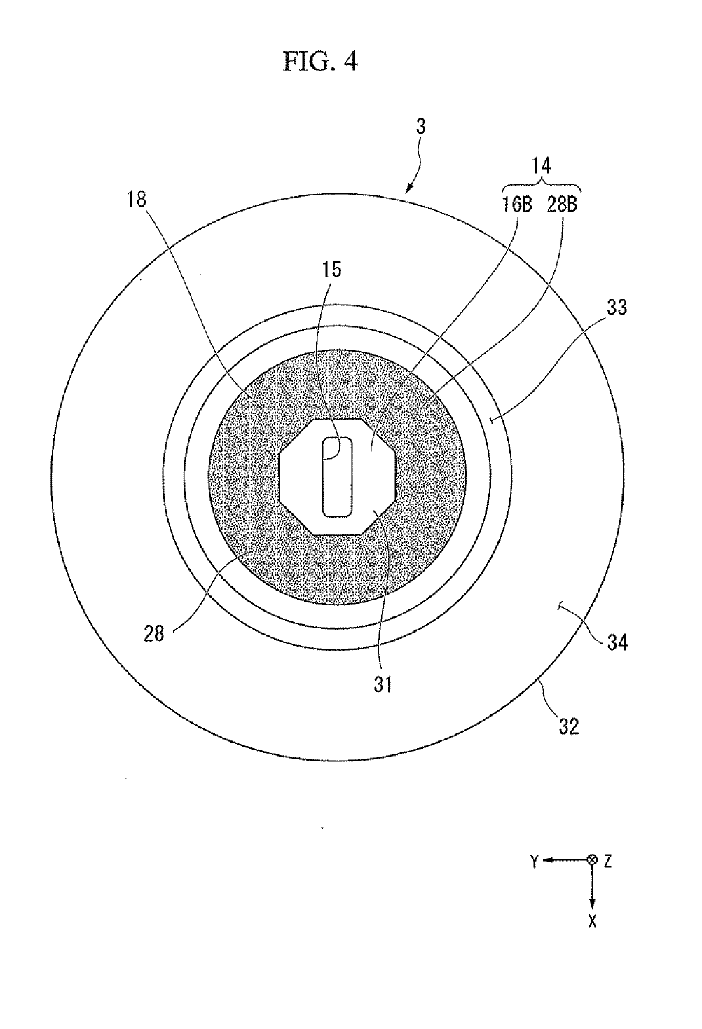

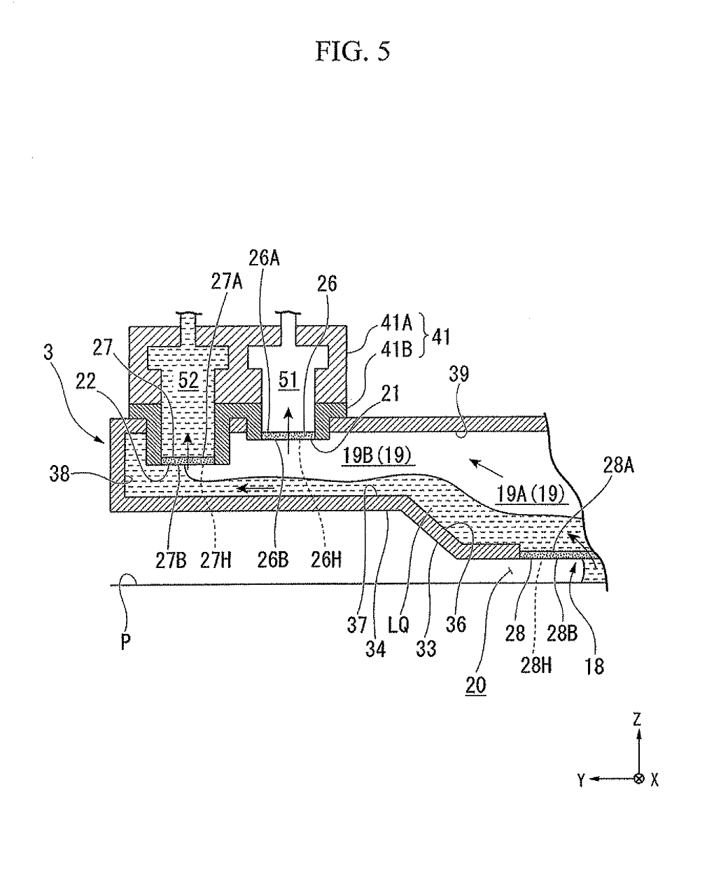

FIG. 2 is a side cross sectional view that shows one example of the liquid immersion member 3 according to the present embodiment; FIG. 3 is a view that shows the liquid immersion member 3 from the upper side (i.e., the +Z side); FIG. 4 is a view that shows the liquid immersion member 3 from the lower side (i.e., the −Z side); and FIG. 5 is a partial enlarged view of FIG. 2. The text below explains an exemplary case, referencing FIG. 2 through FIG. 5, wherein the substrate P is disposed in the projection area PR, but the substrate stage 2 (i.e., the plate member T) can also be disposed in the projection area PR as discussed above.

In the present embodiment, the liquid immersion member 3 comprises a plate part 131, at least part of which is disposed such that it opposes the emergent surface 7, a main body part 32, at least part of which is disposed such that it opposes a side surface 8F of the last optical element 8, and a passageway forming member 41. In the present embodiment, the plate part 131 and the main body part 32 are one body. In the present embodiment, the passageway forming member 41 is different from the plate part 131 and the main body part 32. In the present embodiment, the passageway forming member 41 is supported by the main body part 32. Alternatively, the plate part 131 can have a shape different from a plate-like shape.

Furthermore, the side surface 8F is disposed around the emergent surface 7. In the present embodiment, the side surface 8F is inclined upward toward the outer side in radial directions with respect to the optical path K.

The liquid immersion member 3 has an opening 15, which is formed at a position at which it faces the emergent surface 7. The exposure light EL that emerges from the emergent surface 7 can be radiated through the opening 15 to the substrate P. In addition, the liquid immersion member 3 has a lower surface 16B, which is disposed around the opening 15 and which the front surface of the substrate P can oppose. The lower surface 16B holds the liquid LQ between itself and the front surface of the substrate P. At least part of the lower surface 14 of the liquid immersion member 3 includes the lower surface 16B. In the present embodiment, the lower surface 16B is flat. In the present embodiment, the opening 15 and the lower surface 16B are disposed in the plate part 31.

In the present embodiment, the liquid immersion member 3 has: a plurality of supply ports 17, which are capable of supplying the liquid LQ; a recovery port 18, which is capable of recovering the liquid LQ; a recovery passageway 19, wherethrough the liquid LQ recovered via the recovery port 18 flows; a plurality of first suction ports 21, which face the recovery passageway 19 and wherethrough the gas in the recovery passageway 19 is suctioned; and a plurality of second suction ports 22, which face the recovery passageway 19 and wherethrough the liquid LQ in the recovery passageway 19 is suctioned. Alternatively, the number of the support port 17 can be one. Alternatively, the number of the first suction port 21 can be one. Alternatively, the number of the second suction port 22 can be one.

The supply ports 17 are capable of supplying the liquid LQ to the optical path K. In the present embodiment, the supply ports 17 supply the liquid LQ to the optical path K during at least part of the exposure of the substrate P. The recovery port 18 is capable of recovering at least some of the liquid LQ on the substrate P (i.e., on the object). In the present embodiment, the recovery port 18 recovers at least some of the liquid LQ on the substrate P during at least part of the exposure of the substrate P. The supply ports 17 are disposed in the vicinity of the optical path K such that they face the optical path K. At least part of each of the supply ports 17 may face the side surface 8F. In other words, alternatively, at least part of at least one of the supply ports 17 can face the side surface 8F. The recovery port 18 faces the direction. The front surface of the substrate P faces the recovery port 18 during at least part of the exposure of the substrate P.

The recovery passageway 19 is connected to the recovery port 18. At least part of the recovery passageway 19 is formed inside the liquid immersion member 3. In the present embodiment, the recovery port 18 includes an opening that is formed at one end of the recovery passageway 19.

The first suction ports 21 are disposed such that they face the recovery passageway 19. In the present embodiment, the first suction ports 21 are disposed above (in the +Z direction of) the recovery port 18 such that they face the recovery passageway 19.

The second suction ports 22 are disposed such that they face the recovery passageway 19. In the present embodiment, the second suction ports 22 are disposed above (i.e., in the +Z direction of) the recovery port 18 such that they face the recovery passageway 19.

In the present embodiment, at least part of each of the second suction ports 22 is disposed below the corresponding first suction port 21. In the present embodiment, all of each of the second suction ports 22 is disposed below the corresponding first suction port 21. Furthermore, only part of each of the second suction ports 22 may be disposed below the corresponding first suction port 21.

Furthermore, at least part of each of the second suction ports 22 may be disposed above the corresponding first suction port 21. In other words, alternatively, at least part of at least one of the second suction port 22 can be disposed above the corresponding first suction port 21. For example, all of each of the second suction ports 22 may be disposed above the corresponding first suction port 21. Furthermore, only part of each of the second suction ports 22 may be disposed above the corresponding first suction port 21. Furthermore, at least part of each of the second suction ports 22 may be disposed at the same height as the corresponding first suction port 21. In other words, alternatively, at least part of at least one of the second suction ports 22 can be disposed at the same height as the corresponding first suction port 21.

In the present embodiment, at least part of each of the second suction ports 22 is disposed on the outer side of the corresponding first suction port 21 in the radial directions with respect to the optical path K of the exposure light EL. In the present embodiment, all of each of the second suction ports 22 is disposed on the outer side of the corresponding first suction port 21 in radial directions with respect to the optical path K. Furthermore, only part of each of the second suction ports 22 may be disposed on the outer side of the corresponding first suction port 21 in the radial directions with respect to the optical path K.

Furthermore, at least part of each of the second suction ports 22 may be disposed on the inner side of the corresponding first suction port 21 in the radial directions with respect to the optical path K. In other words, alternatively, at least part of at least one of the second suction ports 22 can be disposed on the inner side of (or located medial to) the corresponding first suction port 21 in the radial directions with respect to the optical path K. For example, all of each of the second suction ports 22 may be disposed on the inner side of the corresponding first suction port 21 in the radial directions with respect to the optical path K. Furthermore, only part of each of the second suction ports 22 may be disposed on the inner side of the corresponding first suction port 21 in the radial directions with respect to the optical path K.

In the present embodiment, the first suction ports 21 or the second suction ports 22, or both, face downward (i.e., in the −Z direction). In the present embodiment, both the first suction ports 21 and the second suction ports 22 face downward. In the present embodiment, the all of each of the first suction ports 21 faces downward. In addition, in the present embodiment, the all of each of the second suction ports 22 faces downward.

Furthermore, at least part of each of the first suction ports 21 does not have to face the −Z direction. In other words, alternatively, at least part of at least one of the first suction ports 21 can face toward a direction different from the −Z direction. For example, at least part of each of the first suction ports 21 may be disposed such that it faces the inner side in the radial directions with respect to the optical path K. For example, part of each of the first suction ports 21 may be disposed such that it faces downward, and part may be disposed such that it faces the inner side in the radial directions with respect to the optical path K. In addition, at least part of each of the first suction ports 21 may be disposed such that it faces toward the outer side in the radial directions with respect to the optical path K.

Furthermore, at least part of each of the second suction ports 22 does not have to face the −Z direction. In other words, alternatively, at least part of at least one of the second suction ports 22 can face toward a direction different from the −Z direction. For example, at least part of each of the second suction ports 22 may be disposed such that it faces the inner side in the radial directions with respect to the optical path K. For example, part of each of the second suction ports 22 may be disposed such that it faces downward, and part may be disposed such that it faces the inner side in the radial directions with respect to the optical path K. In addition, at least part of each of the second suction ports 22 may be disposed such that it faces the outer side in the radial directions with respect to the optical path K.

Furthermore, at least part of each of the first suction ports 21 may face upward, and at least part of each of the second suction ports 22 may face upward.

In addition, in the present embodiment, at least part of each of the first suction ports 21 is disposed on the outer side of the recovery port 18 in the radial directions with respect to the optical path K. In the present embodiment, all of each of the first suction ports 21 is disposed on the outer side of the recovery port 18 in radial directions with respect to the optical path K. Furthermore, part of each of the first suction ports 21 may be disposed on the outer side of the recovery port 18 in radial directions with respect to the optical path K. Furthermore, at least part of each of the first suction ports 21 may be disposed on the inner side of the recovery port 18 in the radial directions with respect to the optical path K. In other words, alternatively, at least part of at least one of the first suction ports 21 can be disposed on the inner side of (or located medial to) the recovery port 18 in the radial directions with respect to the optical path K.

In addition, in the present embodiment, at least part of each of the second suction ports 22 is disposed on the outer side of the recovery port 18 in the radial directions with respect to the optical path K. In the present embodiment, all of each of the second suction ports 22 is disposed on the outer side of the recovery port 18 in radial directions with respect to the optical path K. Furthermore, part of each of the second suction ports 22 may be disposed on the outer side of the recovery port 18 in the radial directions with respect to the optical path K. Furthermore, at least part of each of the second suction ports 22 may be disposed on the inner side of the recovery port 18 in the radial directions with respect to the optical path K. In other words, alternatively, at least part of at least one of the second suction ports 22 can be disposed on the inner side of (or located medial to) the recovery port 18 in the radial directions with respect to the optical path K.

In the present embodiment, the passageway forming member 41 comprises first passageways 51 and second passageways 52. In the present embodiment, each of the first suction ports 21 includes an opening that is formed at one end of the corresponding first passageway 51. Each of the second suction ports 22 includes an opening that is formed at one end of the corresponding second passageway 52.

Each of the first suction ports 21 is connected to a first suction apparatus 24 via the corresponding first passageway 51 and a passageway 23, which is formed by a suction piping 23P. Each of the second suction ports 22 is connected to a second suction apparatus 25 via the corresponding second passageway 52 and a passageway 124, which is formed by a suction piping 124P. Each of the first and second suction apparatuses 24, 25 comprises, for example, a vacuum system and is capable of suctioning a fluid (comprising a gas or a liquid, or both).

In the present embodiment, a suction operation of the first suction ports 21 is performed by the operation of the first suction apparatus 24. In addition, in the present embodiment, a suction operation of the second suction ports 22 is performed by the operation of the second suction apparatus 25.

Furthermore, the exposure apparatus EX comprises the first suction apparatus 24 or the second suction apparatus 25, or both. Furthermore, the first suction apparatus 24 or the second suction apparatus 25, or both, may be an apparatus that is external to the exposure apparatus EX. Furthermore, the first suction apparatus 24 or the second suction apparatus 25, or both, may be equipment in the factory wherein the exposure apparatus EX is installed.

In the present embodiment, the liquid immersion member 3 comprises first porous members 26, which are disposed in the first suction ports 21. Each of the first porous members 26 has a plurality of holes 26H wherethrough the fluid (comprising gas or liquid, or both) can flow. In the present embodiment, the first porous members 26 are plate shaped members. Each of the first porous members 26 has: a first surface 26B, which faces the recovery passageway 19 and is disposed around one end of each of the holes 26H; and a second surface 26A, which is disposed around the other end of each of the holes 26H. Each hole of the plurality of holes 26H is formed such that it connects the first surface 26B and the second surface 26A. In the state wherein the given first porous member 26 is disposed in the corresponding first suction port 21, the corresponding second surface 26A faces the corresponding first passageway 51, and the corresponding first surface 26B faces the recovery passageway 19. Furthermore, each of the first porous members 26 may be a mesh filter, which is a porous member wherein numerous small holes are formed as a mesh.

In the present embodiment, in the state wherein the given first porous member 26 is disposed in the corresponding first suction port 21, the corresponding second surface 26A faces upward and the corresponding first surface 26B faces downward. In the explanation below, the second surfaces 26A are called the upper surfaces 26A where appropriate, and the first surfaces 26B are called the lower surfaces 26B where appropriate.

In the present embodiment, the liquid immersion member 3 comprises second porous members 27, which are disposed in the second suction ports 22. Each of the second porous members 27 has a plurality of holes 27H, wherethrough a fluid (comprising gas or liquid, or both) can pass. In the present embodiment, the second porous members 27 are plate shaped members. Each of the second porous members 27 has: a third surface 27B, which faces the recovery passageway 19 and is disposed around one end of each of the holes 27H; and a fourth surface 27A, which is disposed around the other end of each of the holes 27H. Each hole of the plurality of holes 27H is formed such that it connects the corresponding third surface 27B and the corresponding fourth surface 27A. In the state wherein the given second porous member 27 is disposed in the corresponding second suction port 22, the corresponding third surface 27A faces the corresponding second passageway 52, and the corresponding fourth surface 27B faces the recovery passageway 19. Furthermore, each of the second porous members 27 may be a mesh filter, which is a porous member wherein numerous small holes are formed as a mesh.

In the present embodiment, in the state wherein the given second porous member 27 is disposed in the corresponding second suction port 22, the corresponding fourth surface 27A faces upward and the corresponding third surface 27B faces downward. In the explanation below, the fourth surfaces 27A are called the upper surfaces 27A where appropriate, and the third surfaces 27B are called the lower surfaces 27B where appropriate.

In the present embodiment, the surface of each of the first porous members 26 is liquid repellent (less affinity) with respect to the liquid LQ. The surface of each of the first porous members 26 includes the corresponding upper surface 26A, the corresponding lower surface 26B, and at least part of the inner surfaces (i.e., inner side surfaces) of the corresponding holes 26H. In the present embodiment, the contact angle of the liquid LQ with respect to the surface of each of the first porous members 26 is 90° or greater. Furthermore, the contact angle of the liquid LQ with respect to the surface of each of the first porous members 26 may be 100° or greater, 110° or greater, or 120° or greater.

In the present embodiment, the surface of each of the second porous members 27 is lyophilic (affinity) with respect to the liquid LQ. In the present embodiment, at least part of the surface of each of the second porous members 27 is more lyophilic with respect to the liquid LQ than that of the surface of each of the first porous members 26. In other words, at least part of the surface of each of the first porous members 26 is more liquid repellent with respect to the liquid LQ than that of the surface of each of the second porous members 27. The surface of each of the second porous members 27 includes the corresponding upper surface 27A, the corresponding lower surface 27B, and at least part of the inner surfaces (i.e., inner side surfaces) of the corresponding holes 27H. In the present embodiment, the contact angle of the liquid LQ with respect to the surface of each of the second porous members 27 is less than 90°. Furthermore, the contact angle of the liquid LQ with respect to the surface of each of the second porous members 27 may be less than 50°, less than 40°, less than 30°, or less than 20°.

In the present embodiment, the liquid immersion member 3 comprises a third porous member 28, which is disposed in the recovery port 18. The third porous member 28 has a plurality of holes 28H, wherethrough a fluid (comprising gas or liquid, or both) can pass. In the present embodiment, the third porous member 28 is a plate shaped member. The third porous member 28 has: a fifth surface 28A, which faces the recovery passageway 19 and is disposed around one end of each of the holes 28H; and a sixth surface 28B, which is disposed around the other end of each of the holes 28H. Each hole of the plurality of holes 28H is formed such that it connects the fifth surface 28A and the sixth surface 28B. In the state wherein the third porous member 28 is disposed in the recovery port 18, the fifth surface 28A faces the recovery passageway 19 and the sixth surface 28B faces a space 20 between the liquid immersion member 3 and the substrate P. Furthermore, the third porous member 28 may be a mesh filter, which is a porous member wherein numerous small holes are formed as a mesh.

In the present embodiment, in the state wherein the third porous member 28 is disposed in the recovery port 18, the fifth surface 28A faces upward and the sixth surface 28B faces downward. In the explanation below, the fifth surface 28A is called the upper surface 28A where appropriate, and the sixth surface 28B is called the lower surface 28B where appropriate.

In the present embodiment, the surface of the third porous member 28 is lyophilic with respect to the liquid LQ. The surface of the third porous member 28 includes the upper surface 28A, the lower surface 28B, and at least part of the inner surfaces (i.e., inner side surfaces) of the holes 28H. In the present embodiment, the contact angle of the liquid LQ with respect to the surface of the third porous member 28 is 90° or greater. Furthermore, the contact angle of the liquid LQ with respect to the surface of the third porous member 28 may be less than 50°, less than 40°, less than 30°, or less than 20°.

In the present embodiment, the lower ends of the holes 26H of the given first porous member 26 may be regarded as the corresponding first suction port that suctions the fluid from the recovery passageway 19. In addition, the lower ends of the holes 27H of the given second porous member 27 may be regarded as the corresponding second suction port that suctions the fluid from the recovery passageway 19. In addition, the lower ends of the holes 28H of the third porous member 28 may be regarded as the recovery port that recovers the fluid from the space 20.

In the present embodiment, the lower surface 14 of the liquid immersion member 3 includes the lower surface 16B and the lower surface 28B. In the present embodiment, the lower surface 28B is disposed at least partly around the lower surface 16B. In the present embodiment, the lower surface 28B is disposed around the lower surface 16B. Furthermore, a plurality of the lower surfaces 28B (i.e., the recovery ports 18) may be disposed around the lower surface 16B. In other words, alternatively, a plurality of the lower surfaces 28B (i.e., the recovery ports 18) can be disposed around the optical path K. The plurality of the lower surfaces 28B (i.e., the recovery ports 18) may be disposed at prescribed intervals around the lower surface 16B. In other words, alternatively, the plurality of the lower surfaces 28B (i.e., the recovery ports 18) can be disposed at prescribed intervals around the optical path K.

Furthermore, as shown in FIG. 4, in the present embodiment, the external shape of the lower surface 16B is octagonal, but it may have the shape of any arbitrary polygon such as a quadrilateral, a hexagon, and the like. In addition, the external shape of the lower surface 16B may be circular, elliptical, and the like.

The liquid immersion member 3 comprises supply passageways 29, which are connected to the supply ports 17. At least part of each of the supply passageways 29 is formed inside the liquid immersion member 3. In the present embodiment, each of the supply ports 17 includes an opening, which is formed at one end of the corresponding supply passageway 29. The other end of each of the supply passageways 29 is connected to a liquid supply apparatus 31 via a passageway 30 formed by a supply piping 30P.

The liquid supply apparatus 31 is capable of supplying the liquid LQ, which is clean and temperature adjusted. The liquid LQ that is supplied from the liquid supply apparatus 31 is supplied to the supply ports 17 via the passageway 30 and the supply passageways 29. The liquid LQ supplied to the optical path K through the supply ports 17 flows through the passageway 30 and the supply passageways 29.

As discussed above, in the present embodiment, the opening 15 and the lower surface 16B are disposed in the plate part 131. In addition, the plate part 131 has an upper surface 16A, which faces the opposite direction of the lower surface 16B. At least part of the upper surface 16A opposes the emergent surface 7. The upper surface 16A is disposed around the upper end of the opening 15. The lower surface 16B is disposed around the lower end of the opening 15. The opening 15 is formed such that it connects the upper surface 16A and the lower surface 16B.

In the present embodiment, the lower surface 16B is substantially parallel to the XY plane. Furthermore, at least part of the lower surface 16B may be tilted with respect to the XY plane and may include a curved surface.

In the present embodiment, the upper surface 16A is substantially parallel to the XY plane. Furthermore, at least part of the upper surface 16A may be tilted with respect to the XY plane and may include a curved surface.

The supply ports 17 and the recovery port 18 are formed in the main body part 32. The third porous member 28 is disposed in the recovery port 18 of the main body part 32.

The main body part 32 has: an inclined surface 33, which is disposed at least partly around the lower surface 28B and is tilted upward toward the outer side in the radial directions with respect to the optical path K; and a lower surface 34, which is disposed around the inclined surface 33. The inclined surface 33 and the lower surface 34 are disposed above the lower surfaces 16B, 28B. In addition, the main body part 32 has an inner side surface 35, which opposes the side surface 8F of the last optical element 8. In the present embodiment, the inner side surface 35 is disposed such that it surrounds at least part of the last optical element 8. Furthermore, the inclined surface 33 may be parallel to the Z axis. In addition, instead of providing the inclined surface 33, the lower surface 34 may be disposed in the same plane as the lower surfaces 16B, 28B.

In addition, in the present embodiment, at least part of the recovery passageway 19 is defined by: the upper surface 28A of the third porous member 28; a first inner surface 36, which is disposed at least partly around the upper surface 28A and is tilted upward toward the outer side in the radial directions with respect to the optical path K; a second inner surface 37, which is disposed around the first inner surface 36; a third inner surface 38, which faces toward the inner side in the radial directions with respect to the optical path K; a fourth inner surface 39, which is disposed such that it opposes the upper surface 28A, the first inner surface 36, and the second inner surface 37; and a fifth inner surface 40, which is disposed such that it connects an inner side edge of the upper surface 28A and an inner side edge of the fourth inner surface 39. In the present embodiment, the first through fifth inner surfaces 36-40 are disposed in the main body part 32.

In the present embodiment, the distance between the fourth inner surface 39 and the first inner surface 36 (i.e., the distance in the Z axial directions) is smaller than the distance between the fourth inner surface 39 and the upper surface 28A. The distance between the fourth inner surface 39 and the second inner surface 37 is smaller than the distance between the fourth inner surface 39 and the upper surface 28A.

In the present embodiment, the recovery passageway 19 includes: a space 19A between the fourth inner surface 39 and the upper surface 28A; and a space 19B between the fourth inner surface 39 and the second inner surface 37. In the explanation below, the space 19A between the fourth inner surface 39 and the upper surface 28A is called the first space 19A where appropriate, and the space 19B between the fourth inner surface 39 and the second inner surface 37 is called the second space 19B where appropriate.

In the present embodiment, the upper surface 28A (i.e., the recovery port 18) faces the first space 19A. The lower surfaces 26B (i.e., the first suction ports 21) and the lower surfaces 27B (i.e., the second suction ports 22) face the second space 19B. In the present embodiment, the second suction ports 22 are disposed in an end part of the recovery passageway 19 in radial directions with respect to the optical path K. Namely, in the present embodiment, the second suction ports 22 are disposed in the outer edge part of the recovery passageway 19. In the present embodiment, the second suction ports 22 are disposed in the vicinity of the third inner surface 38. Furthermore, at least part of each of the second suction ports 22 may be provided in the third inner surface 38. In other words, alternatively, at least part of at least one of the second suction ports 22 can be provided in the third inner surface 38.

The passageway forming member 41 has the first passageways 51, the second passageways 52, the first suction ports 21, and the second suction ports 22. The first passageways 51 and the second passageways 52 are formed inside the passageway fanning member 41. In the present embodiment, the passageway forming member 41 is disposed in the opening formed by the main body part 32.

In the present embodiment, the passageway forming member 41 comprises a first member 41A and a second member 41B, which is connected to the first member 41A. In the present embodiment, the second member 41B is disposed in the opening formed by the main body part 32. In the present embodiment, the material with which the first member 41A is formed is different from the material with which the second member 41B is formed. Furthermore, the material with which the first member 41A is formed may be the same as the material with which the second member 41B is formed. Furthermore, the passageway forming member 41 may be a single member. Furthermore, the passageway forming member 41 may be a combination of three or more members.

Furthermore, the member that has the first suction ports 21 may be different from the member that has the second suction ports 22. Furthermore, the main body part 32 and the passageway forming member 41 may be one body.

In the present embodiment, the amount of the gas suctioned via the first suction ports 21 is greater than the amount of the liquid LQ suctioned via the first suction ports 21. In the present embodiment, the first suction ports 21 suction only gas from the recovery passageway 19. In the present embodiment, the first porous members 26, which are liquid repellent with respect to the liquid LQ, are disposed in the first suction ports 21, and only gas is suctioned via the holes 26H of the first porous members 26.

In the present embodiment, the amount of the liquid LQ suctioned via the second suction ports 22 is greater than the amount of the gas suctioned via the second suction ports 22. In the present embodiment, the second suction ports 22 suction only the liquid LQ from the recovery passageway 19. In the present embodiment, the second porous members 27, which are lyophilic with respect to the liquid LQ, are disposed in the second suction ports 22, and only the liquid LQ is suctioned via the holes 27H of the second porous members 27.

In the present embodiment, the pressure differential between the space on the lower surfaces 26B sides (i.e., the recovery passageway 19) and the spaces on the upper surfaces 26A sides (i.e., the first passageways 51) is adjusted such that only gas is suctioned via the holes 26H.

In addition, the pressure differential between the space on the lower surfaces 27B sides (i.e., the recovery passageway 19) and the spaces on the upper surfaces 27A sides (i.e., the second passageways 52) is adjusted such that only the liquid LQ is suctioned via the holes 27H.

In addition, in the present embodiment, the recovery port 18 recovers the gas together with the liquid LQ on the substrate P. In the present embodiment, the pressure differential between the space 20 on the lower surface 28B side and the space on the upper surface 28A side (i.e., the recovery passageway 19) is adjusted such that at least the liquid LQ is recovered via the holes 28H of the third porous member 28.

In the present embodiment, the first suction ports 21 suction only the gas from the recovery passageway 19 and continue to suction that gas. Because the first suction ports 21 continue to suction the gas in the recovery passageway 19, the pressure in the recovery passageway 19 decreases. Because the first suction ports 21 continue to suction the gas from the recovery passageway 19 by the operation of the first suction apparatus 24, the pressure in the recovery passageway 19 decreases to a pressure lower than the pressure in the space 20 between the liquid immersion member 3 and the substrate P. Furthermore, in the present embodiment, the pressure in the space 20 is atmospheric pressure. Furthermore, the pressure in the space 20 may be lower than atmospheric pressure or may be higher than atmospheric pressure.

Because of the decrease in the pressure in the recovery passageway 19, the liquid LQ on the substrate P flows into the recovery passageway 19 via the recovery port 18 (i.e., the holes 28H). In the present embodiment, at least some of the liquid LQ on the substrate P that contacts the third porous member 28 flows into the recovery passageway 19 via the holes 28H of the third porous member 28. In addition, the recovery port 18 (i.e., the holes 28H) recover the gas together with the liquid LQ.

Part of the recovery passageway 19 is a liquid LQ space and part is a gas space. The first suction ports 21 continue to suction the gas from the recovery passageway 19. The second suction ports 22 suction the liquid LQ from the recovery passageway 19.

In the present embodiment, a plurality of the first suction ports 21 is disposed around the optical path K. In addition, in the present embodiment, a plurality of the second suction ports 22 is disposed around the optical path K. As shown in FIG. 3, in the present embodiment, the first suction ports 21 are disposed at four locations around the optical path K. The second suction ports 22 are disposed at four locations around the optical path K. In the present embodiment, two of the first suction ports 21 are disposed along a first axis that passes through the optical path K (i.e., the optical axis AX) and is parallel to the Y axis, and the remaining two first suction ports 21 are disposed along a second axis that passes through the optical path K (i.e., the optical axis AX) and is parallel to the X axis. Namely, in the present embodiment, the first suction ports 21 are disposed—one each—on the +Y side, the −Y side, the +X side, and the −X side of the optical path K. Likewise, two of the second suction ports 22 are disposed along the first axis that passes through the optical path K (i.e., the optical axis AX) and is parallel to the Y axis, and the remaining two second suction ports 22 are disposed along the second axis that is parallel to the X axis. Namely, in the present embodiment, the second suction ports 22 are disposed—one each—on the +Y side, the −Y side, the +X side, and the −X side of the optical path K.

Furthermore, the number and the positions of the first suction ports 21 as well as the second suction ports 22 may be prescribed arbitrarily. For example, the first suction ports 21 and the second suction ports 22 do not have to be disposed along the same axes. For example, the first suction ports 21 may be disposed as they are in FIG. 3, two of the second suction ports 22 may be disposed along a third axis that passes through the optical path K (i.e., the optical axis AX) and that intersects the first axis within the XY plane at approximately 45°, and the other two second suction ports 22 may be disposed along a fourth axis that intersects the first axis at approximately 45°. Namely, the four second suction ports 22 may be disposed at positions shifted from the positions shown in FIG. 3 by approximately 45° in the circumferential directions of the optical path K.

In addition, the first suction ports 21 may be disposed at, for example, two locations or eight locations. In addition, the second suction ports 22 may be disposed at two locations or eight locations. In addition, the number of the first suction ports 21 and the number of the second suction ports 22 may be different. In addition, one second suction port 22 may be provided as a continuous annulus around the optical path K (i.e., the optical axis AX).

As discussed above, in the present embodiment, the pressure differential between the spaces on the upper surfaces 26A sides and the space on the lower surfaces 26B sides is adjusted such that only gas is suctioned via the holes 26H of the first porous members 26.

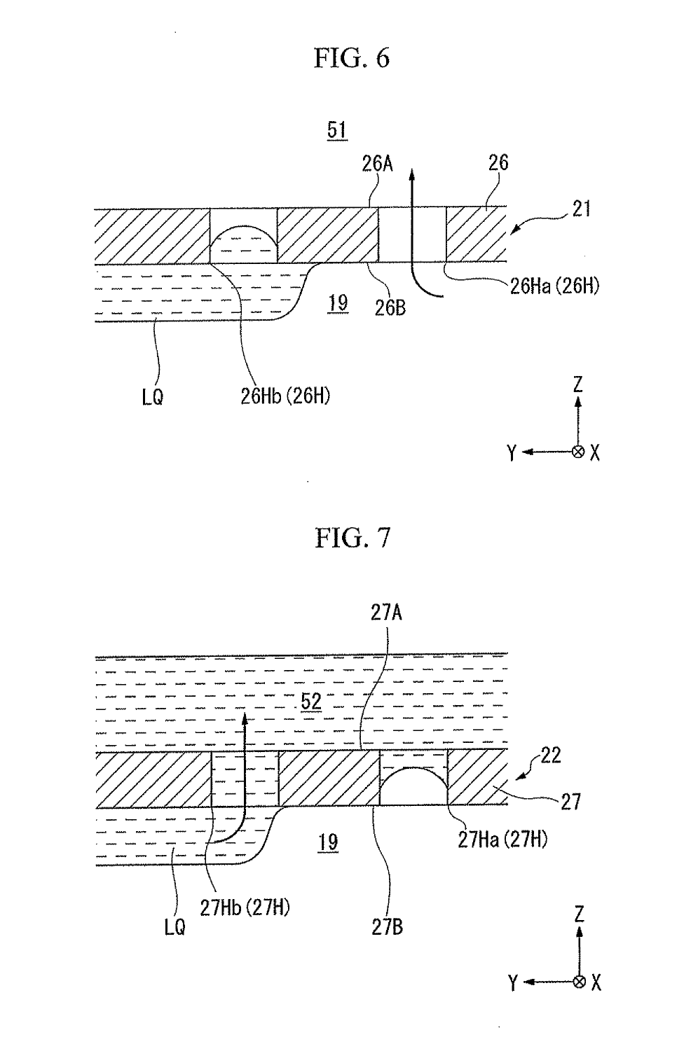

The text below explains the principle of a gas suction operation via the first suction ports 21 (i.e., the holes 26H), referencing FIG. 6. FIG. 6 is a partial enlarged cross sectional view of one of the first porous members 26 and is a schematic drawing for explaining the gas suction operation, which is performed via the first porous members 26.

In FIG. 6, the first porous member 26 is disposed in the first suction port 21. A gas space and a liquid space are formed in the recovery passageway 19, which the lower surface 26B of the first porous member 26 faces. More specifically, the space that the lower end of a first hole 26Ha of the first porous member 26 faces is a gas space, and the space that the lower end of a second hole 26Hb of the first porous member 26 faces is the liquid space. In addition, the first passageway 51 (i.e., the passageway space) is formed on the upper side of the first porous member 26.

The first suction apparatus 24 of the present embodiment adjusts the pressure in the passageway space 51 (i.e., the gas space) such that the condition below is satisfied.

(4×γ×cos θ)/d<(Pb−Pa) (1)

Therein, Pa is the pressure in the liquid space that the lower end of the second hole 26Hb faces (i.e., the pressure on the lower surface 26B side), Pb is the pressure in the passageway space 51 (i.e., the gas space) on the upper side of the first porous member 26 (i.e., the pressure on the upper surface 26A side), d is the hole diameter (i.e., the diameter) of the holes 26Ha, 26Hb, θ is the contact angle of the liquid LQ with respect to the first porous member 26 (i.e., the inner surfaces of the holes 26H), and γ is the surface tension of the liquid LQ.

In such a case, the contact angle θ of the liquid LQ with respect to the first porous member 26 (i.e., the inner surface of the hole 26H) satisfies the condition below.

θ>90° (2)

If the above condition is established, then, even if the liquid space is formed on the lower side of the second hole 26Hb (i.e., the recovery passageway 19 side), the liquid LQ in the liquid space on the lower side of the first porous member 26 is hindered from moving to (i.e., penetrating) the passageway space 51 on the upper side of the first porous member 26 via the second hole 26Hb. Namely, optimizing the hole diameter d of the first porous member 26, the contact angle θ (i.e., affinity) of the liquid LQ with respect to the first porous member 26, the surface tension γ of the liquid LQ, and the pressures Pa, Pb such that the above condition is satisfied makes it possible to keep the interface between the liquid LQ and the gas on the inner side of the second hole 26Hb and to hinder the liquid LQ from penetrating the passageway space 51 from the liquid space via the second hole 26Hb. Moreover, because the gas space can be formed on the lower side of the first hole 26Ha (i.e., on the recovery passageway 19 side), it is possible to suction only the gas via the first hole 26Ha.

Thus, in the present embodiment, by controlling the pressure differential between the spaces 51 on the upper sides of the first porous members 26 and the liquid space on the lower sides of the first porous members 26 (i.e., the pressure differential between the upper surfaces 26A sides and the lower surfaces 26B sides) such that the above condition is satisfied, substantially only the gas is suctioned via the holes 26H of the first porous members 26. Thereby, the first suction ports 21 can continue to suction the gas.

As discussed above, in the present embodiment, the pressure differential between the spaces on the upper surfaces 27A sides and the space on the lower surfaces 27B sides is adjusted such that only the liquid LQ is suctioned via the holes 27H of the second porous members 27.

The text below explains the principle of a liquid suction operation via the second suction ports 22 (i.e., the holes 27H), referencing FIG. 7. FIG. 7 is a partial enlarged cross sectional view of one of the second porous members 27, and is a schematic drawing for explaining the liquid suction operation, which is performed via the second porous members 27.

In FIG. 7, the second porous member 27 is disposed in the second suction port 22. A gas space and a liquid space are formed in the recovery passageway 19, which the lower surface 27B of the second porous member 27 faces. More specifically, the space that the lower end of a third hole 27Ha of the second porous member 27 faces is a gas space, and the space that the lower end of a fourth hole 27Hb of the second porous member 27 faces is a liquid space. In addition, the second passageway 52 (i.e., the passageway space) is formed on the upper side of the second porous member 27.

The second suction apparatus 25 of the present embodiment is set such that the condition below is satisfied.

(4×γ×cos θ)/d>(Pd−Pc) (3)

Therein, Pd is the pressure in the gas space that the lower end of the third hole 27Ha faces (i.e., the pressure on the lower surface 27B side), Pc is the pressure in the passageway space 52 (i.e., the liquid space) on the upper side of the second porous member 27 (i.e., the pressure on the upper surface 27A side), d is the hole diameter (i.e., the diameter) of the holes 27Ha, 27Hb, θ is the contact angle of the liquid LQ with respect to the second porous member 27 (i.e., the inner surfaces of the holes 27H), and γ is the surface tension of the liquid. LQ. Furthermore, to simplify the explanation, the condition expressed in the abovementioned equation (3) does not take the hydrostatic pressure of the liquid LQ on the upper side of the second porous member 27 into consideration.

In such a case, the contact angle θ of the liquid LQ with respect to the second porous member 27 (i.e., the inner surfaces of the holes 27H) satisfies the condition below.

θ<90° (4)

If the above condition is established, then, even if the gas space is formed on the lower side of the third hole 27Ha of the second porous member 27 (i.e., on the recovery passageway 19 side), the gas in the gas space on the lower side of the second porous member 27 is hindered from moving to (i.e., penetrating) the passageway space 52 from the upper side of the second porous member 27 via the third hole 27Ha. Namely, optimizing the hole diameter d of the second porous member 27, the contact angle θ (i.e., affinity) of the liquid LQ with respect to the second porous member 27, the surface tension γ of the liquid LQ, and the pressures Pd, Pe such that the above condition is satisfied makes it possible to keep the interface between the liquid LQ and the gas on the inner side of the third hole 27Ha and to hinder the gas from penetrating the passageway space 52 from the recovery passageway 19 via the third hole 27Ha. Moreover, because the liquid space is formed on the lower side of the fourth hole 27Hb (on the recovery passageway 19 side), it is possible to recover only the liquid LQ via the fourth hole 27Hb.

Thus, in the present embodiment, in the state wherein the second porous member 27 is wetted, by controlling the pressure differential between the space 52 on the upper side of the second porous member 27 and the gas space on the lower side of the second porous member 27 (i.e., the pressure differential between the upper surface 27A side and the lower surface 27B side) such that the above condition is satisfied, substantially only the liquid LQ is recovered from the holes 27H of the second porous member 27.

The following text explains a method of using the exposure apparatus EX that has the abovementioned configuration to expose the substrate P. After the unexposed substrate P has been loaded onto the substrate holding part 10, the control apparatus 4 forms the immersion space LS by holding the liquid LQ between the lower surface 14 of the liquid immersion member 3 and the front surface of the substrate P such that the optical path K of the exposure light EL between the emergent surface 7 and the front surface of the substrate P is filled with the liquid LQ.

In the present embodiment, the control apparatus 4 is capable of forming the immersion space LS with the liquid LQ between the last optical element 8 and the liquid immersion member 3 on one side and the substrate P (i.e., the object) on the other side by performing a recovery operation, which recovers the liquid LQ via the liquid recovery port 18, in parallel with a supply operation, which supplies the liquid LQ via the supply ports 17.

The control apparatus 4 starts the process of exposing the substrate P. The control apparatus 4 radiates the exposure light EL, which emerges from the mask M illuminated with the exposure light EL from the illumination system IL, to the substrate P through the projection optical system PL and the liquid LQ in the immersion space LS. Thereby, the substrate P is exposed by the exposure light EL, which transits the liquid LQ in the immersion space LS and emerges from the emergent surface 7, and thus the image of the pattern of the mask M is projected to the substrate P.

When recovering the liquid LQ via the recovery port 18, the control apparatus 4 operates the first suction apparatus 24 to suction the gas from the recovery passageway 19 via the first suction ports 21. Thereby, the pressure in the recovery passageway 19 decreases. Because the pressure in the recovery passageway 19 decreases to a pressure lower than the pressure in the space 20 between the liquid immersion member 3 and the substrate P, the liquid LQ on the substrate P flows into the recovery passageway 19 via the recovery port 18 (i.e., the third porous member 28). Namely, because a pressure differential is generated between the upper surface 28A and the lower surface 28B of the third porous member 28, the liquid LQ on the substrate P flows into the recovery passageway 19 via the recovery port 18 (i.e., the third porous member 28). During the recovery of the liquid LQ via the recovery port 18, the first suction ports 21 continue to suction the gas from the recovery passageway 19.

To suction only the gas from the recovery passageway 19, the first suction parts 21 hinder the pressure in the recovery passageway 19 from fluctuating greatly. Namely, the pressure in the recovery passageway 19 is held substantially constant by ensuring a continuous gas passageway between the first suction apparatus 24 and the gas space at the upper part of the recovery passageway 19 and by the first suction ports 21 continuing to suction the gas from the recovery passageway 19. Because the pressure in the recovery passageway 19 is substantially constant, fluctuations in the amount of liquid recovered per unit of time from above the substrate P (i.e., from the immersion space LS) via the recovery port 18 are hindered. In the present embodiment, to form the immersion space LS, the supply ports 17 supply a prescribed amount of the liquid LQ per unit of time. In the present embodiment, the supply ports 17 continue to supply a substantially constant amount of the liquid LQ. In addition, the recovery port 18 recovers a prescribed amount of the liquid LQ per unit of time. In the present embodiment, the recovery port 18 continues to recover a substantially constant amount of the liquid LQ. Accordingly, large fluctuations in the immersion space LS are hindered.

In the present embodiment, the liquid LQ that flows into the recovery passageway 19 via the recovery port 18 is suctioned via the second suction ports 22. The liquid LQ recovered via the recovery port 18 flows toward the second suction ports 22 (i.e., the second porous members 27) while making contact with, for example, the first inner surface 36, the second inner surface 37, and the third inner surface 38. The liquid LQ in the recovery passageway 19 that contacts any of the second suction ports 22 (i.e., the second porous members 27) is suctioned via those second suction ports 22. The liquid LQ is suctioned from the recovery passageway 19 via the second suction ports 22 such that the flow of the gas from the recovery passageway 19 into the first suction ports 21 is maintained. The control apparatus 4 controls the first suction apparatus 24 or the second suction apparatus 25, or both, such that the suctioning of the gas via the first suction ports 21 continues and such that the liquid LQ is suctioned via the second suction ports 22.

In the present embodiment, because the first suction ports 21 (i.e., the lower surfaces 26B) are disposed above the second suction ports 22 (i.e., the lower surfaces 27B), contact between the first suction ports 21 (i.e., the lower surfaces 26B) and the liquid LQ that flows into the recovery passageway 19 via the recovery port 18 is hindered, and the majority of the liquid LQ is recovered via the second suction ports 22. Accordingly, by ensuring the continuous gas passageway between the first suction apparatus 24 and the gas space in the upper part of the recovery passageway 19 (i.e., the gas space in the recovery passageway 19 in the vicinities of the first suction ports 21) and by the first suction ports 21 continuing to suction the gas from the recovery passageway 19, the pressure in the recovery passageway 19 (i.e., the gas space) is substantially constant.

In addition, in the present embodiment, because the first suction ports 21 are disposed on the outer side of the recovery port 18 in the radial directions with respect to the optical path K and because the second suction ports 22 are disposed in the end part of the recovery passageway 19 on the outer sides of the first suction ports 21 in the radial directions with respect to the optical path K, the liquid LQ that flows from the recovery port 18 into the recovery passageway 19 flows in the lower part of the recovery passageway 19 over the first inner surface 36 and the second inner surface 37 toward the third inner surface 38 in the radial directions with respect to the optical path K and is recovered via the second suction ports 22 while making virtually no contact with the first suction ports 21 (i.e., the lower surfaces 26B). Accordingly, by ensuring a continuous gas passageway between the first suction apparatus 24 and the gas space in the upper part of the recovery passageway 19 (i.e., the gas space in the recovery passageway 19 in the vicinities of the first suction ports 21) and by the first suction ports 21 continuing to suction the gas from the recovery passageway 19, the pressure in the recovery passageway 19 (i.e., the gas space) stabilizes.

In addition, in the present embodiment, because the first suction ports 21 are disposed on the outer side of the recovery port 18 in the radial directions with respect to the optical path K and because the third inner surface 38 is disposed torically around the optical path K (i.e., the optical axis AX), the liquid LQ that flows from the recovery port 18 into the recovery passageway 19—for example, the liquid LQ that flows in the radial directions with respect to the optical path K toward the space between two of the adjacent second suction ports 22—also flows smoothly along the third inner surface 38 toward any of the second suction ports 22 and is recovered via the second suction ports 22 while making virtually no contact with the first suction ports 21 (i.e., the lower surfaces 26B). Accordingly, by ensuring a continuous gas passageway between the first suction apparatus 24 and the gas space in the upper part of the recovery passageway 19 (i.e., the gas space in the recovery passageway 19 in the vicinities of the first suction ports 21) and by the first suction ports 21 continuing to suction the gas from the recovery passageway 19, pressure fluctuations in the recovery passageway 19 (i.e., the gas space) are hindered and the liquid LQ on the object opposing the recovery port 18 is recovered.

According to the present embodiment as explained above, the desired immersion space LS can be formed. Accordingly, it is possible to prevent exposure failures from occurring and defective devices from being produced.

### Second Embodiment

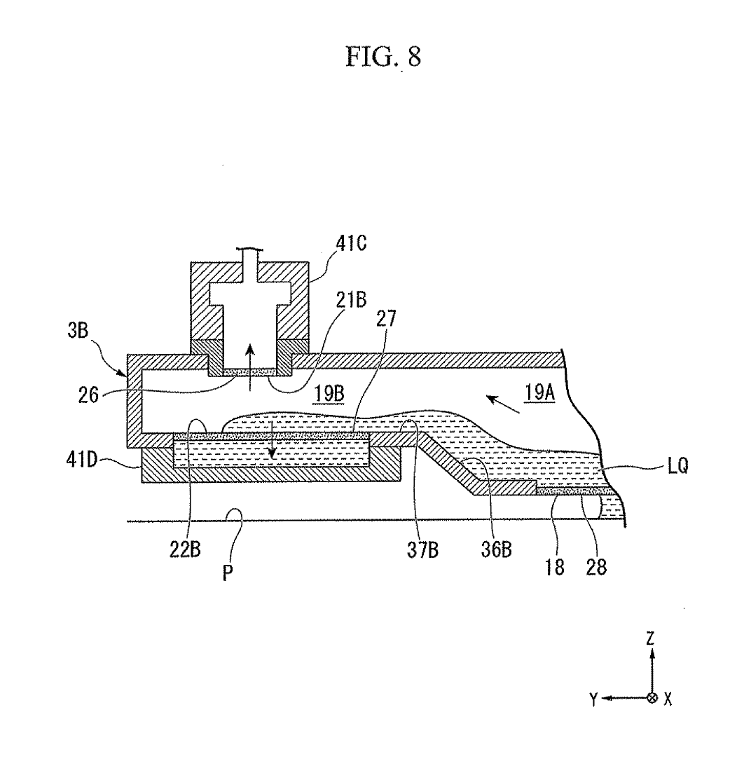

A second embodiment will now be explained. FIG. 8 is a side cross sectional view that shows part of an immersion member 3B according to the second embodiment. The second embodiment is a modified example of the first embodiment. In the explanation below, constituent parts that are identical or equivalent to those in the embodiment discussed above are assigned identical symbols, and the explanations thereof are therefore abbreviated or omitted.

As shown in FIG. 8, the liquid immersion member 3B according to the present embodiment comprises a second suction port 22B, which is disposed below a first suction port 21B. In the present embodiment, the second suction port 22B faces upward (i.e., in the +Z direction).

In addition, in the present embodiment, at least part of the second suction port 22B is disposed on the inner side of the first suction port 21B in the radial directions with respect to the optical path K. In the present embodiment, at least part of the first suction port 21B opposes at least part of the second suction port 22B. In the present embodiment, the first suction port 21B and the second suction port 22B are disposed such that the first suction port 21B and part of the second suction port 22B are opposed. The second suction port 22B is disposed such that it faces the second space 19B. The first suction port 21B is also disposed such that it faces the second space 19B. In addition, in the present embodiment, at least part of the second suction port 22B is disposed at the end part of the recovery passageway 19 in the radial directions with respect to the optical path K. In addition, in the present embodiment, part of the second suction port 22B is disposed on the outer side of the first suction port 21B in the radial directions with respect to the optical path K.

The first suction port 21B is disposed in a passageway forming member 41C. The first porous member 26 is disposed in the first suction port 21B. The first suction port 21B (i.e., the first porous member 26) suctions only the gas from the recovery passageway 19. Furthermore, the passageway forming member 41C may be formed as a plurality of members or as a single member, as in the first embodiment.

The second suction port 22B is disposed in a passageway forming member 41D. The second porous member 27 is disposed in the second suction port 22B. The holes of the porous member 27 may be considered as the second suction port 22B. In the present embodiment, the amount of the liquid LQ suctioned via the second suction port 22B is greater than the amount of the gas suctioned via the second suction port 22B. The second suction port 22B (i.e., the second porous member 27) suctions only the liquid LQ from the recovery passageway 19. Furthermore, the passageway forming member 41D may be formed as a plurality of members or as a single member, as in the first embodiment.

Furthermore, at least two or more elements selected from the group consisting of the passageway forming member 41C, the passageway forming member 41D, and the main body part 32 may be one body.

In the present embodiment, too, the liquid LQ that flows from the recovery port 18 into the recovery passageway 19 is recovered via the second suction port 22B. The liquid LQ recovered via the recovery port 18 flows over a first inner surface 36B and a second inner surface 37B in the lower part of the recovery passageway 19 toward the third inner surface 38 and flows toward the second suction port 22B (i.e., the second porous member 27); furthermore, the liquid LQ in the recovery passageway 19 that contacts the second suction port 22B (i.e., the second porous member 27) is suctioned via that second suction port 22B. The second suction port 22B suctions the liquid LQ from the recovery passageway 19 such that the flow of the gas from the recovery passageway 19 to the first suction port 21B is maintained. The control apparatus 4 controls the first suction apparatus 24 or the second suction apparatus 25, or both, such that the suctioning of the gas via the first suction port 21B continues and such that the liquid LQ is suctioned via the second suction port 22B.

In the present embodiment, because the second suction port 22B is disposed below the first suction port 21B such that it opposes the first suction port 21B, the liquid LQ that flows from the recovery port 18 into the recovery passageway 19 is recovered via the second suction port 22B while making virtually no contact with the first suction port 218 (i.e., the first porous member 26). Namely, by ensuring a continuous gas passageway between the first suction apparatus 24 and the gas space of the recovery passageway 19 and by the first suction port 21B continuing to suction the gas from the recovery passageway 19, the pressure in the recovery passageway 19 becomes substantially constant.

In addition, in the present embodiment, because part of the second suction port 22B is disposed on the inner side of the first suction port 21B in the radial directions with respect to the optical path K, the liquid LQ that flows from the recovery port 18 into the recovery passageway 19 is recovered via the second suction port 22B while making virtually no contact with the first suction port 21B (i.e., the first porous member 26). Accordingly, by ensuring a continuous gas passageway between the first suction apparatus 24 and the gas space of the recovery passageway 19 and by the first suction port 21B continuing to suction the gas from the recovery passageway 19, the pressure in the recovery passageway 19 stabilizes.

In addition, in the present embodiment, because part of the second suction port 22B is disposed on the outer side of the first suction port 21B in the radial directions with respect to the optical path K, the liquid LQ that flows from the recovery port 18 into the recovery passageway 19—for example, the liquid LQ that flows in the radial directions with respect to the optical path K toward the space between two of the adjacent second suction ports 22B—also flows along the third inner surface 38 toward any of the second suction ports 22B and is recovered via the second suction ports 22B while making virtually no contact with the first suction ports 21B. Accordingly, by ensuring a continuous gas passageway between the first suction apparatus 24 and the gas space of the recovery passageway 19 and by the first suction ports 21B continuing to suction the gas from the recovery passageway 19, the liquid LQ on the object opposing the recovery port 18 is recovered while hindering pressure fluctuations in the recovery passageway 19 (i.e., the gas space). Furthermore, at least part of the second suction port 22B does not have to be disposed on the inner side of the first suction port 21B in the radial directions with respect to the optical path K. At least part of at least one of the second suction ports 22B can be disposed at a position different from the inner side position of (or the medial side position with respect to) the first suction port(s) 21B. In addition, part of the second suction port 22B does not have to be disposed on the outer side of the first suction port 21B in the radial directions with respect to the optical path K. At least part of at least one of the second suction ports 22B can be disposed at a position different from the outer side position of (or the lateral side position with respect to) the first suction port(s) 21B. For example, the outer edge part of the second suction port 22B and the outer edge part of the first suction port 21B may be disposed at substantially the same position in the radial directions with respect to the optical path K. Alternatively or also, at least part of at least one of the second suction ports 22B can face toward a direction different from the +Z direction. Alternatively or also, at least part of at least one of the second suction ports 22B can be provided as a continuous annulus around the second inner surface 37B.

Furthermore, at least one of the various modified examples discussed in the first embodiment may be adapted to the second embodiment.

### Third Embodiment

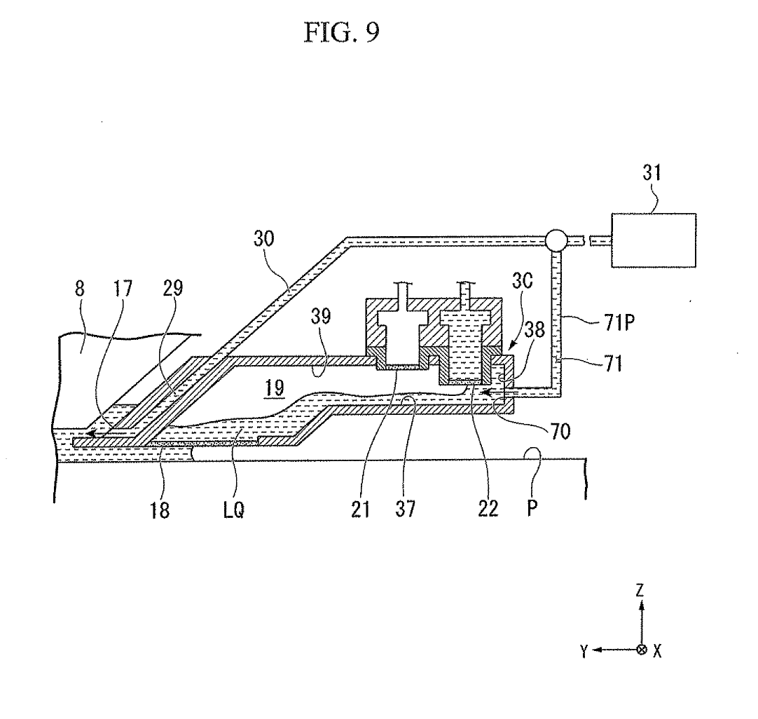

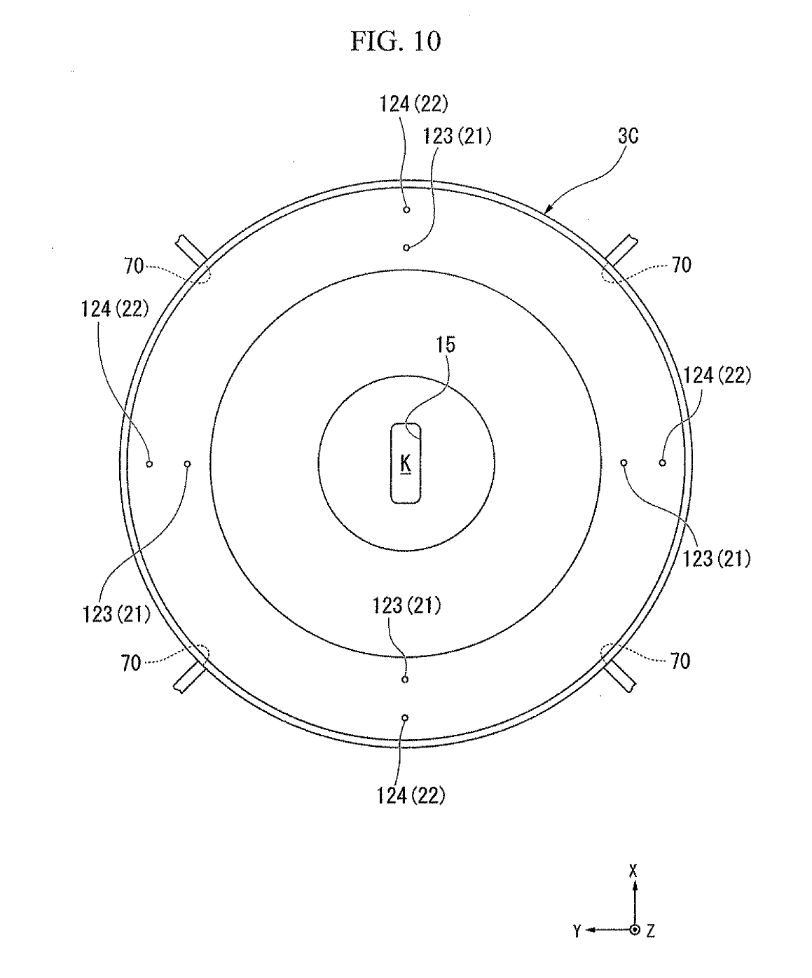

A third embodiment will now be explained. FIG. 9 and FIG. 10 are side cross sectional views that show part of a liquid immersion member 3C according to the third embodiment. The third embodiment is a modified example of the first embodiment. In the explanation below, constituent parts that are identical or equivalent to those in the embodiment discussed above are assigned identical symbols, and the explanations thereof are therefore abbreviated or omitted.

FIG. 9 is a side cross sectional view that shows one example of the liquid immersion member 3C according to the third embodiment, and FIG. 10 shows one example of the liquid immersion member 3C, viewed from the upper side, according to the third embodiment. The liquid immersion member 3C according to the third embodiment comprises supply ports 70, which supply the liquid LQ to the recovery passageway 19.

In FIG. 9 and FIG. 10, the liquid immersion member 3C comprises the supply ports 70, which supply the liquid LQ to the recovery passageway 19. The supply ports 70 that supply the liquid LQ to the recovery passageway 19 are different from the supply ports 17 that supply the liquid LQ to the optical path K.

In the present embodiment, the supply ports 70 are disposed in the third inner surface 38. Furthermore, the supply ports 70 may be disposed in, for example, the second inner surface 37 or the fourth inner surface 39.

In the present embodiment, a plurality of the supply ports 70 is disposed around the optical path K. As shown in FIG. 10, in the present embodiment, the supply ports 70 are disposed at four locations around the optical path K. In the present embodiment, each of the supply ports 70 is disposed between two of the first suction ports 21 that are adjacent in the circumferential directions of the optical path K (i.e., the optical axis AX). In the present embodiment, each of the supply ports 70 is disposed substantially midway between two of the first suction ports 21.

Furthermore, at least one of the supply ports 70 may be disposed below the first suction ports 21 or below the second suction ports 22. In addition, at least one of the supply ports 70 may be disposed above the first suction ports 21 or above the second suction ports 22. In addition, at least one of the supply ports 70 may be disposed on the outer sides or the inner sides of the first suction ports 21 in radial directions with respect to the optical path K. In addition, at least one of the supply ports 70 may be disposed on the outer sides or the inner sides of the second suction ports 22 in the radial directions with respect to the optical path K.

In the present embodiment, the supply ports 70 supply at least some of the liquid LQ from the passageway 30 to the recovery passageway 19. In the present embodiment, the exposure apparatus EX comprises a branch piping 71P, which has a branch passageway 71 that is connected to the passageway 30. The supply ports 70 are connected to the branch passageway 71. The supply ports 70 supply to the recovery passageway 19 at least some of the liquid LQ that branches from the passageway 30 to the branch passageway 71.

The temperature of at least part of the liquid immersion member 3C may be adjusted by the liquid LQ supplied to the recovery passageway 19 via the supply ports 70; alternatively, temperature fluctuations in at least part of the liquid immersion member 3C may be hindered by the liquid LQ supplied to the recovery passageway 19 via the supply ports 70. If the liquid LQ and the gas are recovered together via the recovery port 18, then temperature fluctuations in at least part of the liquid immersion member 3C owing to the vaporization of the liquid LQ may be hindered by the liquid LQ supplied to the recovery passageway 19 via the supply ports 70. In addition, the pressure in the recovery passageway 19 (e.g., the pressure in the gas space) and the like may be adjusted by supplying the liquid LQ to the recovery passageway 19 via the supply ports 70. In addition, any foreign matter present in the recovery passageway 19 may be eliminated by supplying the liquid LQ to the recovery passageway 19 via the supply ports 70. For example, the liquid LQ supplied to the recovery passageway 19 via the supply ports 70 may adjust the flow of the liquid LQ in the recovery passageway 19 and guide any foreign matter present in the recovery passageway 19 to the first suction ports 21 or the second suction ports 22, or both.

In addition, the flow of the liquid LQ in the recovery passageway 19 may be adjusted by supplying the liquid LQ to the recovery passageway 19 via the supply ports 70. For example, one of the supply ports 70 may be provided in the vicinity of a space wherein the flow of the liquid LQ in the recovery passageway 19 that was recovered via the recovery port 18 is slow (i.e., a so-called stagnation space), and the flow of the liquid LQ in the recovery passageway 19 may be adjusted and any foreign matter in the stagnation space may be eliminated by supplying the liquid LQ to the stagnation space via that supply port 70. In addition, the flow of the liquid LQ in the recovery passageway 19 may be adjusted by adjusting the flow velocity of the liquid LQ (i.e., the amount of the liquid LQ supplied per unit of time) supplied via the supply ports 70. In the present embodiment, each of the supply ports 70 is disposed between two of the first suction ports 21 that are adjacent in the circumferential directions of the optical path K (i.e., the optical axis AX), and the liquid LQ supplied via the supply ports 70 promotes the flow of the liquid LQ along the third inner surface 38 toward the second suction ports 22. Accordingly, the liquid LQ that flows from the recovery port 18 into the recovery passageway 19—for example, the liquid LQ that flows toward the space between two of the adjacent first suction ports 21—also flows along the third inner surface 38 toward the second suction ports 22 together with the liquid LQ supplied via the supply ports 70 and is recovered via the second suction ports 22. Accordingly, contact between the first suction ports 21 (i.e., the first porous members 26) and the liquid LQ that flows from the recovery port 18 into the recovery passageway 19 is hindered. Furthermore, a flow of the liquid LQ toward the second suction ports 22 along the third inner surface 38 may be formed by jetting the liquid LQ via the supply ports 70 diagonally so that it follows the third inner surface 38.

In addition, a configuration may be adopted wherein, if the recovery passageway 19 contains a space wherein the liquid LQ recovered via the recovery port 18 flows (i.e., the liquid space) and a space wherein the liquid LQ recovered via the recovery port 18 does not flow (i.e., the gas space), then the liquid LQ supplied via the supply ports 70 is supplied to that gas space.

Furthermore, in the third embodiment, at least some of the liquid LQ supplied via the passageway 30 (29) is supplied to the recovery passageway 19; however, the liquid LQ may be supplied to the recovery passageway 19 other than via the passageway 30 (29) wherein the liquid LQ supplied to the supply ports 17 flows. For example, the liquid LQ may be supplied to the recovery passageway 19 via the supply ports 70 from a liquid supply source other than that of the liquid supply apparatus 31.

In addition, the temperature of the liquid LQ supplied via the supply ports 70 may be different from that of the liquid LQ supplied via the supply ports 17. For example, the temperature of the liquid LQ supplied via the supply ports 70 may be higher or lower than that of the liquid LQ supplied via the supply ports 17. For example, if the temperature of at least part of the liquid immersion member 3C decreases owing to the vaporization of the liquid LQ as discussed above, then the temperature of the liquid LQ supplied via the supply ports 70 may be set higher than that of the liquid LQ supplied via the supply ports 17.

In addition, the temperature of the liquid LQ supplied via the supply ports 70 may be different from that of the liquid LQ recovered via the recovery port 18 (i.e., the temperature of the liquid LQ that flows from the recovery port 18 into the recovery passageway 19). For example, the temperature of the liquid LQ supplied via the supply ports 70 may be higher or lower than the temperature of the liquid LQ recovered via the recovery port 18.

In addition, the temperature of the liquid immersion member 3 may be adjusted by adjusting the temperature of the liquid LQ supplied via the supply ports 70.

In addition, the type (i.e., the physical properties) of the liquid supplied via the supply ports 70 may be different from that of the liquid LQ supplied via the supply ports 17.

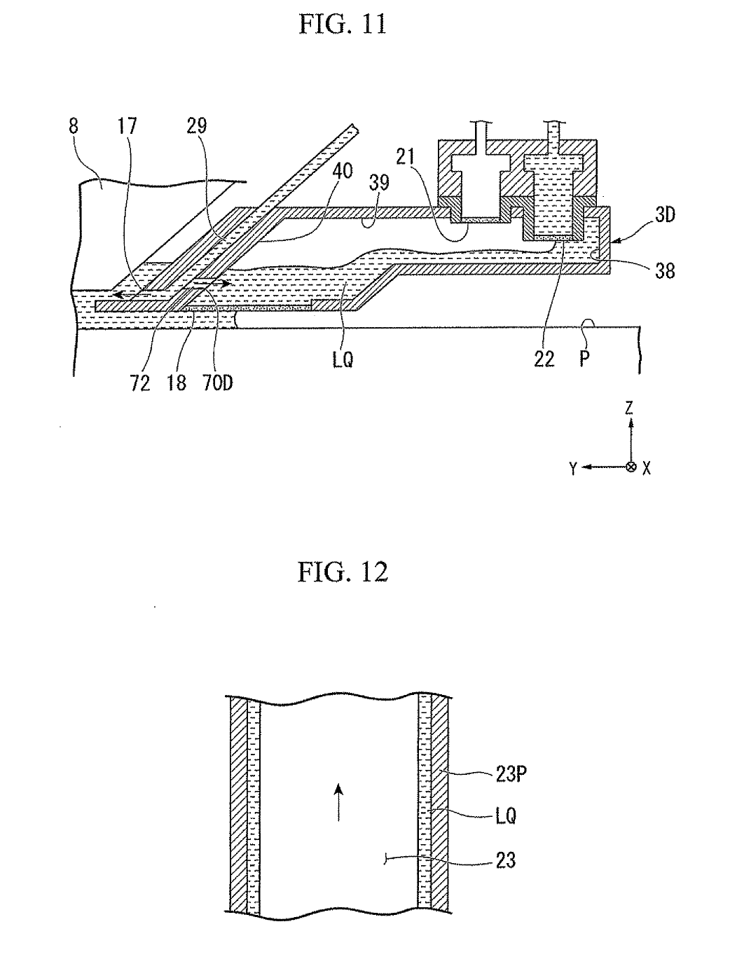

Furthermore, the supply ports 70 may be disposed in the vicinities of the first suction ports 21. Furthermore, the supply ports 70 may be disposed in the vicinities of the second suction ports 22. Furthermore, as shown in FIG. 11, a branch passageway 72 that branches from the supply passageway 29 may be provided inside a liquid immersion member 3D. A supply port 70D supplies to the recovery passageway 19 at least some of the liquid LQ that branched from the supply passageway 29 to the branch passageway 72. Furthermore, in the example shown in FIG. 11, the supply port 70D is disposed in the fifth inner surface 40. Furthermore, the supply port 70D may be disposed in the fourth inner surface 39 or in the third inner surface 38.

In addition, the gas may be supplied to the recovery passageway 19 via a gas supply port (not shown) other than the supply port 70 (70D). By supplying the gas to the recovery passageway 19 via the gas supply port, the temperature of at least part of the liquid immersion member 3C (3D) may be adjusted or temperature fluctuations in at least part of the liquid immersion member 3C (3D) may be hindered. In addition, by supplying the gas to the recovery passageway 19 via the gas supply port, the pressure in the recovery passageway 19 (i.e., the pressure in the gas space) may be adjusted and the flow of the liquid LQ inside the recovery passageway 19 may be adjusted. In addition, the supply of the gas via the gas supply port may be performed in parallel with the supply of the liquid LQ via the supply port 70 (70D); alternatively, the supply of the gas via the gas supply port does not have to be performed in parallel with the supply of the liquid LQ via the supply port 70 (70D).

Furthermore, a liquid supply port that supplies liquid to the recovery passageway 19 or a gas supply port that supplies gas to the recovery passageway 19, or both, may be provided to the liquid immersion member 3B explained in the second embodiment.

Furthermore, in the first through third embodiments discussed above, the third porous member 28 does not have to be disposed in the recovery port 18. In addition, the first porous members 26 do not have to be disposed in the first suction ports 21 (21B). In addition, the second porous members 27 do not have to be disposed in the second suction ports 22 (22B).

Furthermore, if the first and second porous members 26, 27 are omitted, then at least part of the surfaces of the members that have the second suction ports 22 may be more lyophilic or liquid repellent with respect to the liquid LQ than the surfaces of the members that have the first suction ports 21.

Furthermore, in each of the embodiments discussed above, the first suction ports 21 (21B) may suction the liquid LQ together with the gas from the recovery passageway 19. For example, if the first suction ports 21 (21B) recover both the gas and the liquid LQ, then, as shown in FIG. 12, a configuration may be adopted wherein the liquid LQ flows along the inner surface of the passageway 123 (i.e., the first passageway 51) and the gas flows on the inner side thereof. For example, a configuration may be adopted wherein an annular flow of the liquid LQ is formed inside the passageway 123 (i.e., the first passageway 51). If the liquid LQ flows as shown in FIG. 12, then the first suction port 21 (21B) can continue to suction the gas even if the liquid LQ is suctioned from the recovery passageway 19 together with the gas. Namely, as in the embodiments discussed above, by ensuring a continuous gas passageway between the first suction apparatus 24 and the gas space in the recovery passageway 19 and by stabilizing the gas in the recovery passageway 19 and continuing to suction the gas from the recovery passageway 19 via the first suction port 21B, pressure fluctuations in the recovery passageway 19 are hindered.

Furthermore, in each of the embodiments discussed above, the second suction ports 22 (22B) may suction the gas together with the liquid LQ. In this case, too, by disposing the first suction ports 21 (21B) and the second suction ports 22 (22B) as in the embodiments discussed above, the flow of the liquid LQ, which first flowed into the recovery passageway 19, into the first suction ports 21 (21B) is hindered and the majority of the liquid LQ is recovered via the second suction ports 22 (22B). Namely, as in the embodiments discussed above, by ensuring a continuous gas passageway between the first suction apparatus 24 and the gas space in the recovery passageway 19 and by stabilizing the gas in the recovery passageway 19 and continuing to suction the gas from the recovery passageway 19 via the first suction ports 21 (21B), pressure fluctuations in the recovery passageway 19 are hindered.

Furthermore, in each of the embodiments discussed above, the recovery port 18 may suction substantially only the liquid LQ. In this case, the suction of the first suction ports 21 may be stopped, or the suction ports 21 may recover the liquid LQ without stopping the suction.

Furthermore, in each of the embodiments discussed above, the entire surface of each of the first porous members 26 does not have to be more liquid repellent with respect to the liquid LQ than the second porous members 27 are. For example, part of the surface of each of the first porous members 26 may be more liquid repellent with respect to the liquid LQ than the second porous members 27 are. In addition, at least part of the surface of each of the second porous members 27 may be more liquid repellent with respect to the liquid LQ than the first porous members 26 are.

Furthermore, in each of the embodiments discussed above, the entire surface of each of the second porous members 27 does not have to be more lyophilic with respect to the liquid LQ than the first porous members 26 are. For example, part of the surface of each of the second porous members 27 may be more lyophilic with respect to the liquid LQ than the first porous members 26 are. In addition, at least part of the surface of each of the first porous members 26 may be more lyophilic with respect to the liquid LQ than the second porous members 27 are.

Furthermore, in each of the embodiments discussed above, the “radial directions with respect to the optical path K” may be regarded as the radial directions with respect to the optical axis of the projection optical system PL in the vicinity of the projection area PR.

Furthermore, as discussed above, the control apparatus 4 comprises a computer system, which comprises a CPU and the like. In addition, the control apparatus 4 comprises an interface, which is capable of conducting communication between the computer system and the external apparatus. The storage apparatus 5 comprises memory, such as RAM, and storage media, such as a hard disk, a CD-ROM, and the like. The operating system (OS) that controls the computer system is installed in the storage apparatus 5, and the program for controlling the exposure apparatus EX is stored in the storage apparatus 5.

Furthermore, the control apparatus 4 may be connected to an input apparatus that is capable of inputting an input signal. The input apparatus comprises input equipment, such as a keyboard and a mouse, or a communication apparatus, which is capable of inputting data from the external apparatus. In addition, a display apparatus, such as a liquid crystal display, may be provided.

Various information, including the program stored in the storage apparatus 5, can be read by the control apparatus 4 (i.e., the computer system). In the storage apparatus 5, a program is stored that causes the control apparatus 4 to control the exposure apparatus EX such that the substrate P is exposed with the exposure light EL, which transits the liquid LQ.

The program stored in the storage apparatus 5 may cause the control apparatus 4 to execute the following processes in accordance with the embodiments discussed above: a process that forms the immersion space LS such that the optical path K of the exposure light EL radiated to the substrate P is filled with the liquid LQ; a process that exposes the substrate P with the exposure light EL, which transits the liquid LQ in the immersion space LS; a process that recovers, via the recovery port 18, at least some of the liquid LQ on the substrate P; a process that suctions only the gas from the recovery passageway 19 via the first suction ports 21, which are disposed such that they face the recovery passageway 19 wherein flows the liquid LQ recovered via the recovery port 18; and a process that suctions the liquid LQ from the recovery passageway 19 via the second suction ports 22, which are disposed such that they face the recovery passageway 19.

In addition, the program stored in the storage apparatus 5 may cause the control apparatus 4 to execute the following processes in accordance with the embodiments discussed above: a process that forms the immersion space LS such that the optical path K of the exposure light EL radiated to the substrate P is filled with the liquid LQ; a process that exposes the substrate P with the exposure light EL, which transits the liquid LQ in the immersion space LS; a process that recovers, via the recovery port 18, at least some of the liquid LQ on the substrate P; a process that continues to suction the gas from the recovery passageway 19 via the first suction ports 21, which are disposed such that they face the recovery passageway 19 wherein flows the liquid LQ recovered via the recovery port 18; and a process that suctions the liquid LQ from the recovery passageway 19 via the second suction ports 22, which are disposed such that they face the recovery passageway 19.

In addition, the program stored in the storage apparatus 5 may cause the control apparatus 4 to execute the following processes in accordance with the embodiments discussed above: a process that forms the immersion space LS such that the optical path K of the exposure light EL radiated to the substrate P is filled with the liquid LQ; a process that exposes the substrate P with the exposure light EL, which transits the liquid LQ in the immersion space LS; a process that recovers, via the recovery port 18, at least some of the liquid LQ on the substrate P; a process that suctions, via the holes 26H (i.e., the first suction ports 21) disposed in the first porous members 26 such they face the recovery passageway 19, the gas in the recovery passageway 19 wherein flows the liquid LQ recovered via the recovery port 18; and a process that suctions the liquid LQ from the recovery passageway 19 via the holes 27H (i.e., the second suction ports 22) disposed in the second porous members 27, at least part of the surface of which is more lyophilic with respect to the liquid LQ than the first porous members 26 are, such that the holes 27H face the recovery passageway 19.

In addition, the program stored in the storage apparatus 5 may cause the control apparatus 4 to execute the following processes in accordance with the embodiments discussed above: a process that forms the immersion space LS such that the optical path K of the exposure light EL radiated to the substrate P is filled with the liquid LQ; a process that exposes the substrate P with the exposure light EL, which transits the liquid LQ in the immersion space LS; a process that recovers, via the recovery port 18, at least some of the liquid LQ on the substrate P; a process that suctions the gas from the recovery passageway 19 via the first suction ports 21, which are disposed such that at least part of each faces the recovery passageway 19 wherein flows the liquid LQ recovered via the recovery port 18; and a process that suctions the liquid LQ from the recovery passageway 19 via the second suction ports 22, at least part which are disposed on the outer sides of the first suction ports 21 in the radial directions with respect to the optical path K such that they face the recovery passageway 19.

In addition, the program stored in the storage apparatus 5 may cause the control apparatus 4 to execute the following processes in accordance with the embodiments discussed above: a process that forms the immersion space LS such that the optical path K of the exposure light EL radiated to the substrate P is filled with the liquid LQ; a process that exposes the substrate P with the exposure light EL, which transits the liquid LQ in the immersion space LS; a process that recovers, via the recovery port 18, at least some of the liquid LQ on the substrate P; a process that suctions the gas in the recovery passageway 19 via the first suction ports 21, which are disposed above the recovery port 18 such that they face the recovery passageway 19 wherein flows the liquid LQ recovered via the recovery port 18; and a process that suctions the liquid LQ from the recovery passageway 19 via the second suction ports 22, at least part of which are disposed below the corresponding first suction port 21 such that they face the recovery passageway 19.

The program stored in the storage apparatus 5 is read by the control apparatus 4, and thereby the various processes, such as the immersion exposure of the substrate P in the state wherein the immersion space LS is formed, are executed in cooperation with the various apparatuses of the exposure apparatus EX, such as the substrate stage 2, the liquid immersion member 3, the liquid supply apparatus 31, the first suction apparatus 24, and the second suction apparatus 25.

Furthermore, in the embodiments discussed above, the optical path K on the emergent (i.e., image plane) side of the last optical element 8 of the projection optical system PL is filled with the liquid LQ; however, it is possible to use a projection optical system PL wherein the optical path K on the incident (i.e., object plane) side of the last optical element 8 is also filled with the liquid LQ, as disclosed in, for example, PCT International Publication No. WO2004/019128.

Furthermore, in each of the embodiments discussed above, water is used as the liquid LQ, but a liquid other than water may be used. It is preferable to use, as the liquid LQ, a liquid that is transparent with respect to the exposure light EL, has a high refractive index with respect to the exposure light EL, and is stable with respect to the projection optical system PL or the film of, for example, the photosensitive material (i.e., the photoresist) that forms the front surface of the substrate P. For example, it is also possible to use a fluorine based liquid, such as hydrofluoroether (HFE), perfluorinated polyether (PFPE), Fomblin® oil, or the like, as the liquid LQ. In addition, it is also possible to use various fluids, for example, a supercritical fluid, as the liquid LQ.

Furthermore, the substrate P in each of the embodiments discussed above is not limited to a semiconductor wafer for fabricating semiconductor devices, but can also be adapted to, for example, a glass substrate for display devices, a ceramic wafer for thin film magnetic heads, or the original plate of a mask or a reticle (e.g., synthetic quartz or a silicon wafer) used by an exposure apparatus.

In addition, the exposure apparatus EX can be adapted to a step-and-scan system scanning type exposure apparatus (i.e., a scanning stepper) that scans and exposes the pattern of the mask M by synchronously moving the mask M and the substrate P, as well as to

a step-and-repeat type projection exposure apparatus (i.e., a stepper) that exposes the full field of the pattern of the mask M, with the mask M and the substrate P in a stationary state, and sequentially steps the substrate P.

Furthermore, when performing an exposure with a step-and-repeat system, the projection optical system may be used to transfer a reduced image of a first pattern to the substrate P in a state wherein the first pattern and the substrate P are substantially stationary, after which the projection optical system may be used to perform a full-field exposure of the substrate P, wherein a reduced image of a second pattern partially superposes the transferred first pattern in a state wherein the second pattern and the substrate P are substantially stationary (i.e., as in a stitching type full-field exposure apparatus). In addition, the stitching type exposure apparatus can also be adapted to a step-and-stitch type exposure apparatus that successively steps the substrate P and transfers at least two patterns onto the substrate P such that they are partially superposed.

In addition, the present invention can also be adapted to, for example, an exposure apparatus that combines on a substrate the patterns of two masks through a projection optical system and double exposes, substantially simultaneously, a single shot region on the substrate using a single scanning exposure, as disclosed in, for example, U.S. Pat. No. 6,611,316. In addition, the present invention can also be adapted to, for example, a proximity type exposure apparatus and a mirror projection aligner.

In addition, the exposure apparatus EX may be a twin stage type exposure apparatus, which comprises a plurality of substrate stages, as disclosed in, for example, U.S. Pat. Nos. 6,341,007, 6,208,407, and 6,262,796. For example, if two of the substrate stages are provided, then the object that is capable of being disposed such that it opposes the emergent surface 7 is one of the substrate stages, a substrate held by a substrate holding part on that substrate stage, the other of the substrate stages, the substrate held by a substrate holding part on that other substrate stage, or any combination thereof.

In addition, the exposure apparatus EX can also be adapted to an exposure apparatus that is provided with a substrate stage that holds a substrate and a measurement stage that does not hold the substrate to be exposed and whereon a fiducial member (wherein a fiducial mark is formed) and/or various photoelectric sensors are mounted, as disclosed in, for example, U.S. Pat. No. 6,897,963 and U.S. Patent Application Publication No. 2007/0127006. In such a case, the objects that are capable of being disposed such that they oppose the emergent surface 7 are the substrate stage, the substrate held by the substrate holding part on that substrate stage, and the measurement stage. In addition, the present invention can also be adapted to an exposure apparatus that comprises a plurality of the substrate stages and the measurement stages.

The type of exposure apparatus EX is also not limited to a semiconductor device fabrication exposure apparatus that exposes the pattern of a semiconductor device on the substrate P, but can be widely adapted to exposure apparatuses that are used for fabricating, for example, liquid crystal devices or displays, and exposure apparatuses that are used for fabricating thin film magnetic heads, image capturing devices (e.g., CCDs), micromachines, MEMS, DNA chips, or reticles and masks.

Furthermore, in each of the embodiments discussed above, the position of each of the stages is measured using an interferometer system that comprises laser interferometers, but the present invention is not limited thereto; for example, an encoder system that detects a scale (i.e., a diffraction grating) provided to each of the stages may be used, or the interferometer system may be used in parallel with the encoder system.

Furthermore, in the embodiments discussed above, an optically transmissive mask wherein a prescribed shielding pattern (or phase pattern or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, U.S. Pat. No. 6,778,257, may be used. In addition, instead of a variable shaped mask that comprises a non-emissive type image display device, a pattern forming apparatus that comprises a self-luminous type image display device may be provided.

Each of the embodiments discussed above explained an exemplary case of the exposure apparatus EX that comprises the projection optical system PL, but the present invention can be adapted to an exposure apparatus and an exposing method that do not use the projection optical system PL. For example, the immersion space can be formed between an optical member, such as a lens, and the substrate, and the exposure light can be radiated to the substrate through that optical member.

In addition, the present invention can also be adapted to an exposure apparatus (i.e., a lithographic system) that, by forming interference fringes on the substrate P, exposes the substrate P with a line-and-space pattern, as disclosed in, for example, PCT International Publication No. WO2001/035168.

The exposure apparatus EX according to the embodiments discussed above is manufactured by assembling various subsystems, including each constituent element discussed above, so that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus EX from the various subsystems includes, for example, the connection of mechanical components, the wiring and connection of electrical circuits, and the piping and connection of the pneumatic circuits among the various subsystems. Naturally, prior to performing the process of assembling the exposure apparatus EX from these various subsystems, there are also the processes of assembling each individual subsystem. When the process of assembling the exposure apparatus EX from the various subsystems is complete, a comprehensive adjustment is performed to ensure the various accuracies of the exposure apparatus EX as a whole. Furthermore, it is preferable to manufacture the exposure apparatus EX in a clean room wherein, for example, the temperature and the cleanliness level are controlled.

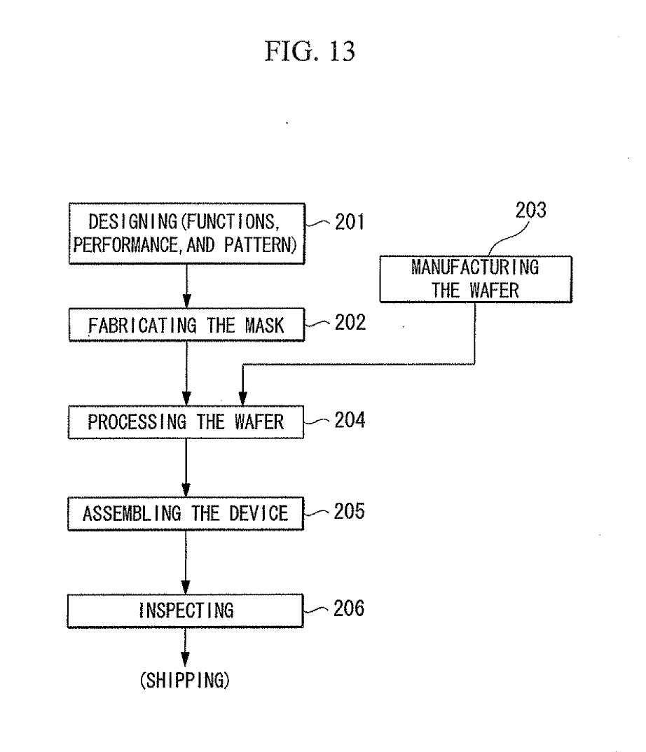

As shown in FIG. 13, a microdevice, such as a semiconductor device, is manufactured by: a step 201 that designs the functions and performance of the microdevice; a step 202 that fabricates the mask (i.e., a reticle) based on this designing step; a step 203 that manufactures the substrate P, which is the base material of the device; a substrate processing step 204 that comprises a substrate process (i.e., an exposure process) that includes, in accordance with the embodiments discussed above, exposing the substrate P with the exposure light EL that emerges from the pattern of the mask M and developing the exposed substrate P; a device assembling step 205 (which includes fabrication processes such as dicing, bonding, and packaging processes); an inspecting step 206; and the like.

Furthermore, the features of each of the embodiments discussed above can be combined as appropriate. In addition, there may be cases wherein some of the constituent elements are not used. In addition, each disclosure of every Japanese published patent application and U.S. patent related to the exposure apparatus recited in each of the embodiments, modified examples, and the like discussed above is hereby incorporated by reference in its entirety to the extent permitted by national laws and regulations.

1. A liquid immersion member of forming an immersion space, comprising:
a recovery port, which recovers at least some of a liquid on an object disposed such that the object faces an emergent surface wherefrom exposure light emerges;
a recovery passageway, wherein flows the liquid recovered via the recovery port;
a first suction port, which faces the recovery passageway and suctions only a gas from the recovery passageway; and
a second suction port, which faces the recovery passageway and suctions the liquid from the recovery passageway.

2. A liquid immersion member of forming an immersion space, comprising:
a recovery port, which recovers at least some of a liquid on an object disposed such that the object faces an emergent surface wherefrom exposure light emerges;
a recovery passageway, wherein flows the liquid recovered via the recovery port;
a first suction port, which faces the recovery passageway and continues to suction a gas from the recovery passageway; and
a second suction port, which faces the recovery passageway and suctions the liquid from the recovery passageway.

3. The liquid immersion member according to claim 2, wherein
the second suction port suctions the liquid from the recovery passageway such that the flow of the gas from the recovery passageway into the first suction port is maintained.

4. The liquid immersion member according to claim 2, wherein
the first suction port suctions only the gas from the recovery passageway.

5. The liquid immersion member according to claim 4, further comprising:
a first porous member, which is disposed in the first suction port;
wherein,
only the gas is suctioned via holes of the first porous member.

6. The liquid immersion member according to claim 5, wherein
the first porous member has a first surface, which faces the recovery passageway and is disposed around one end of the holes, and a second surface, which is disposed around an other end of the holes; and
pressure differential between a space on the first surface side and a space on the second surface side is adjusted such that only the gas is suctioned via the holes.

7. The liquid immersion member according to claim 1, comprising:
a first porous member, which is disposed in the first suction port.

8. The liquid immersion member according to claim 5, wherein
the first porous member is liquid repellent with respect to the liquid.

9. The liquid immersion member according to claim 1, wherein
the second suction port suctions only the liquid from the recovery passageway.

10. The liquid immersion member according to claim 9, further comprising:
a second porous member, which is disposed in the second suction port;
wherein,
only the liquid is suctioned via holes of the second porous member.

11. The liquid immersion member according to claim 10, wherein
the second porous member has a third surface, which faces the recovery passageway and is disposed around one end of the holes, and a fourth surface, which is disposed around an other end of the holes; and
pressure differential between a space on the third surface side and a space on the fourth surface side is adjusted such that only the liquid is suctioned via the holes.

12. The liquid immersion member according to claim 1, further comprising:
a second porous member, which is disposed in the second suction port.

13. The liquid immersion member according to claim 10, wherein
the second porous member is lyophilic with respect to the liquid.

14. A liquid immersion member of forming an immersion space, comprising:
a recovery port, which recovers at least some of a liquid on an object disposed such that the object faces an emergent surface wherefrom exposure light emerges;
a recovery passageway, wherein flows the liquid recovered via the recovery port;
a first member, which has a first suction port that faces the recovery passageway; and
a second member, at least part of whose surface is more lyophilic to the liquid than the first member is, that has a second suction port that faces the recovery passageway;
wherein,
a gas is suctioned from the recovery passageway via the first suction port of the first member; and
the liquid is suctioned from the recovery passageway via the second suction port of the second member.

15. The liquid immersion member according to claim 14, wherein
at least one member selected from the group consisting of the first member and the second member is a porous member.

16. The liquid immersion member according to claim 14, wherein
at least part of the surface of the first member is liquid repellent with respect to the liquid.

17. The liquid immersion member according to claim 1, wherein
at least part of the second suction port is disposed on the outer side of the first suction port in the radial directions with respect to the optical path such that the second suction port faces the recovery passageway.

18. The liquid immersion member according to claim 17, wherein
the second suction port is disposed in an end part of the recovery passageway in the radial directions with respect to the optical path.

19. The liquid immersion member according to claim 1, wherein
at least part of the second suction port is disposed below the first suction port such that the second suction port faces the recovery passageway.

20. The liquid immersion member according to claim 19, wherein
at least part of the first suction port opposes at least part of the second suction port.

21. The liquid immersion member according to claim 1, wherein
at least one of the ports selected from the group consisting of the first suction port and the second suction port faces downward.

22. A liquid immersion member of forming an immersion space, comprising:
a recovery port, which recovers at least some of a liquid on an object disposed such that the object faces an emergent surface wherefrom exposure light emerges;
a recovery passageway, wherein flows the liquid recovered via the recovery port;
a first suction port, which is disposed such that the first suction port faces the recovery passageway, that suctions a gas from the recovery passageway; and
a second suction port, at least part of which is disposed on an outer side of the first suction port in the radial directions with respect to the optical path such that the second suction port faces the recovery passageway, that suctions the liquid in the recovery passageway.

23. The liquid immersion member according to claim 22, wherein
the second suction port is disposed in an end part of the recovery passageway in the radial directions with respect to the optical path.

24. The liquid immersion member according to claim 22, wherein
at least part of the second suction port is disposed below the first suction port such that the second suction port faces the recovery passageway.

25. The liquid immersion member according to claim 24, wherein
at least part of the first suction port opposes at least part of the second suction port.

26. The liquid immersion member according to claim 25, wherein
part of the second suction port is disposed such that the part faces the recovery passageway on the inner side of the first suction port in the radial directions with respect to the optical path.

27. A liquid immersion member of forming an immersion space, comprising:
a recovery port, which recovers at least some of a liquid on an object disposed such that the object faces an emergent surface wherefrom exposure light emerges;
a recovery passageway, wherein flows the liquid recovered via the recovery port;
a first suction port, which is disposed above the recovery port and such that the first suction port faces the recovery passageway, that suctions a gas from the recovery passageway; and
a second suction port, at least part of which is disposed below the first suction port and such that the second suction port faces the recovery passageway, that suctions the liquid in the recovery passageway.

28. The liquid immersion member according to claim 27, wherein
at least part of the first suction port opposes at least part of the second suction port.

29. The liquid immersion member according to claim 28, wherein
at least part of the second suction port is disposed on the inner side of the first suction port in the radial directions with respect to the optical path such that the second suction port faces the recovery passageway.

30. The liquid immersion member according to claim 22, wherein
at least part of the first suction port is disposed on the outer side of the recovery port in the radial directions with respect to the optical path.

31. The liquid immersion member according to claim 22, wherein
at least one of the ports selected from the group consisting of the first suction port and the second suction port faces downward.

32. The liquid immersion member according to claim 22, wherein
the first suction port continues to suction the gas from the recovery passageway during the recovery of the liquid via the recovery port.

33. The liquid immersion member according to claim 22, wherein
the first suction port suctions only the gas from the recovery passageway.

34. The liquid immersion member according to claim 22, wherein
the second suction port suctions only the liquid from the recovery passageway.

35. The liquid immersion member according to claim 22, further comprising:
a first porous member, which is disposed in the first suction port; and
a second porous member, which is disposed in the second suction port;
wherein,
the gas is suctioned from the recovery passageway via holes of the first porous member; and
the liquid is suctioned from the recovery passageway via holes of the second porous member.

36. A liquid immersion member according to claim 1, wherein
the recovery port recovers the gas together with the liquid.

37. The liquid immersion member according to claim 1, wherein
a plurality of the first suction ports is disposed around the optical path.

38. The liquid immersion member according to claim 1, further comprising:
a supply port, which supplies the liquid to the recovery passageway.

39. The liquid immersion member according to claim 38, wherein
a flow of the liquid toward the second suction port is promoted by supplying the liquid via the supply port.

40. The liquid immersion member according to claim 38, further comprising:
a supply passageway wherein flows the liquid supplied to the optical path;
wherein,
the supply port supplies at least some of the liquid from the supply passageway to the recovery passageway.

41. The liquid immersion member according to claim 1, further comprising:
a third porous member, which is disposed in the recovery port.

42. An exposure apparatus that exposes a substrate with exposure light, which transits a liquid, comprising:
a liquid immersion member according to claim 1.

43. A device fabricating method, comprising:
exposing a substrate using an exposure apparatus according to claim 42; and developing the exposed substrate.

44. A liquid recovering method used by an exposure apparatus, which exposes a substrate with exposure light via a liquid of an immersion space, the method comprising:
recovering via a recovery port at least some of the liquid on the substrate;
suctioning via a first suction port, which is disposed such that the first suction port faces a recovery passageway wherethrough flows the liquid recovered via the recovery port, only a gas from the recovery passageway; and
suctioning via a second suction port, which is disposed such that the second suction port faces the recovery passageway, the liquid from the recovery passageway.

45. A liquid recovering method used by an exposure apparatus, which exposes a substrate with exposure light via a liquid of an immersion space, comprising:
recovering via a recovery port at least some of the liquid on the substrate;
continuing to suction via a first suction port, which is disposed such that the first suction port faces a recovery passageway wherethrough flows the liquid recovered via the recovery port, a gas from the recovery passageway; and
suctioning via a second suction port, which is disposed such that the second suction port faces the recovery passageway, the liquid from the recovery passageway.

46. The liquid recovering method according to claim 45, wherein
the second suction port suctions the liquid from the recovery passageway such that the flow of the gas from the recovery passageway into the first suction port is maintained.

47. The liquid recovering method according to claim 45, wherein
the first suction port suctions only the gas from the recovery passageway.

48. The liquid recovering method according to claim 45, wherein
the second suction port suctions only the liquid from the recovery passageway.

49. A liquid recovering method used by an exposure apparatus, which exposes a substrate with exposure light via a liquid of an immersion space, the method comprising:
recovering via a recovery port at least some of the liquid on the substrate;
suctioning via a first suction port, which is disposed in a first member such that the first suction port faces a recovery passageway wherethrough flows the liquid recovered via the recovery port, a gas from the recovery passageway; and
suctioning the liquid from the recovery passageway via a second suction port, which is disposed in a second member, at least part of whose surface is more lyophilic with respect to the liquid than the first member is, such that the second suction port faces the recovery passageway.

50. A liquid recovering method used by an exposure apparatus, which exposes a substrate with exposure light via a liquid of an immersion space, the method comprising:
recovering via a recovery port at least some of the liquid on the substrate;
suctioning via a first suction port, at least part of which is disposed such that the at least part faces a recovery passageway wherethrough flows the liquid recovered via the recovery port, a gas from the recovery passageway; and
suctioning via a second suction port, at least part of which is disposed on the outer side of the first suction port in the radial directions with respect to the optical path such that the second suction port faces the recovery passageway, the liquid from the recovery passageway.

51. A liquid recovering method used by an exposure apparatus, which exposes a substrate with exposure light via a liquid of an immersion space, the method comprising:
recovering via a recovery port at least some of the liquid on the substrate;
suctioning via a first suction port, which is disposed above the recovery port such that the first suction port faces a recovery passageway wherethrough flows the liquid recovered via the recovery port, a gas from the recovery passageway; and
suctioning via a second suction port, part of which is disposed below the first recovery port such that the second suction port faces the recovery passageway, the liquid from the recovery passageway.

52. A device fabricating method, comprising:
filling an optical path of exposure light radiated to a substrate with a liquid using a liquid recovering method according to claim 44;
exposing the substrate with the exposure light, which transits the liquid; and
developing the exposed substrate.

53. A program that causes a computer to control an exposure apparatus, comprising the steps of:
forming an immersion space;
exposing a substrate with exposure light via a liquid of the immersion space;
recovering via a recovery port at least some of the liquid on the substrate;
suctioning via a first suction port, which is disposed such that the first suction port faces a recovery passageway wherethrough flows the liquid recovered via the recovery port, only a gas from the recovery passageway; and
suctioning via a second suction port, which is disposed such that the second suction port faces the recovery passageway, the liquid from the recovery passageway.

54. A program that causes a computer to control an exposure apparatus, comprising the steps of:
forming an immersion space;
exposing a substrate with exposure light via a liquid of the immersion space;
recovering via a recovery port at least some of the liquid on the substrate;
continuing to suction via a first suction port, which is disposed such that the first suction port faces a recovery passageway wherethrough flows the liquid recovered via the recovery port, a gas from the recovery passageway; and
suctioning via a second suction port, which is disposed such that the second suction port faces the recovery passageway, the liquid from the recovery passageway.

55. A program that causes a computer to control an exposure apparatus, comprising the steps of:
forming an immersion space;
exposing a substrate with exposure light via a liquid of the immersion space;
recovering via a recovery port at least some of the liquid on the substrate;
suctioning via a first suction port, which is disposed in a first member such that the first suction port faces a recovery passageway wherethrough flows the liquid recovered via the recovery port, a gas from the recovery passageway; and
suctioning the liquid from the recovery passageway via a second suction port, which is disposed in a second member, at least part of whose surface is more lyophilic with respect to the liquid than the first member is, such that the second suction port faces the recovery passageway.

56. A program that causes a computer to control an exposure apparatus, comprising the steps of:
fowling an immersion space;
exposing a substrate with exposure light via a liquid of the immersion space;
recovering via a recovery port at least some of the liquid on the substrate;
suctioning via a first suction port, which is disposed such that at least part thereof faces a recovery passageway wherethrough flows the liquid recovered via the recovery port, only a gas from the recovery passageway; and
suctioning via a second suction port, at least part of which is disposed on the outer side of the first suction port in the radial directions with respect to the optical path such that the second suction port faces the recovery passageway, the liquid from the recovery passageway.

57. A program that causes a computer to control an exposure apparatus, comprising the steps of:
forming an immersion space;
exposing a substrate with exposure light via a liquid of the immersion space;
recovering via a recovery port at least some of the liquid on the substrate;
suctioning via a first suction port, which is disposed above the recovery port such that the first suction port faces a recovery passageway wherethrough flows the liquid recovered via the recovery port, only a gas from the recovery passageway; and
suctioning via a second suction port, at least part of which is disposed below the first recovery port such the faces the recovery passageway, the liquid from the recovery passageway.

58. A computer readable storage medium, wherein
a program according to claim 53 is stored in the storage medium.
